(19) United States
(12) Patent Application Publication
(10) Pub. No.: US 2026/0343271 A1
(43) Pub. Date: Oct. 29, 2026

(54) METHOD AND APPARATUS FOR MEASUREMENT RESOURCE SHARING FOR WIRELESS COMMUNICATION

(71) Applicant: Apple Inc., Cupertino, CA (US)

(72) Inventors: Jie Cui, San Jose, CA (US); Yang Tang, San Jose, CA (US); Qiming Li, Beijing (CN); Xiang Chen, Palo Alto, CA (US); Manasa Raghavan, Sunnyvale, CA (US); Haitong Sun, Saratoga, CA (US); Yuexia Song, Beijing (CN); Chunxuan Ye, San Diego, CA (US); Dawei Zhang, Saratoga, CA (US); Hong He, San Jose, CA (US)

(21) Appl. No.: 19/114,490

(22) PCT Filed: Sep. 30, 2022
(86) PCT No.: PCT/CN2022/123412

§ 371 Date: Mar. 24, 2025

(51) Int. Cl. H04W 24/08; H04W 72/02

(52) U.S. Cl. CPC H04W 24/08; H04W 72/02

(57) ABSTRACT

A user equipment (UE) is configured to, determine, for a period of time, if all synchronization signal block (SSB) measurement timing configuration (SMTC) occasions are within less than a temporal proximity threshold of any of one or more measurement gap (MG) occasions, and, if so, to allocate measurement resources to provide equal sharing among gapless measurements during a subset of the SMTC occasions and other measurement objects during a subset of the one or more MG occasions. The UE is configured, for the period of time, to determine if any of the SMTC occasions are within less than the temporal proximity threshold of any of the one or more MG occasions, and, if so, to allocate non-overlapped SMTC occasions of the SMTC occasions to be used for gapless measurements, inhibiting use of overlapped SMTC occasions, and allocating the MG occasions to be used for measurement of the other measurement objects.

### FIELD

This disclosure relates to wireless communication including techniques for measurement resource sharing for wireless communication.

### BACKGROUND

Wireless communication networks may include user equipments (UEs), base stations (BSs), and/or other types of wireless devices capable of communicating with one another.

During operation, a UE performs measurements of electromagnetic signals, and the information obtained from measurements may be used to improve communication performance.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a block diagram illustrating a wireless network including a user equipment (UE) and a base station, with the UE implementing a measurement resource sharing scheme in accordance with some aspects of the present disclosure.

FIG. 2 is a timing diagram illustrating a measurement resource sharing for a fully overlapped example in accordance with some aspects of the present disclosure.

FIG. 3 is a timing diagram illustrating measurement resource sharing for a partially overlapped example in accordance with some aspects of the present disclosure.

FIG. 4 is a timing diagram illustrating measurement resource sharing for a partially overlapped example in accordance with some aspects of the present disclosure.

FIG. 5 is a timing diagram illustrating measurement resource sharing for a fully overlapped example with a plurality of measurement gaps (MGs) per measurement gap repetition period (MGRP) in accordance with some aspects of the present disclosure.

FIG. 6 is a timing diagram illustrating measurement resource sharing for a fully overlapped example with a plurality of MGs per MGRP in accordance with some aspects of the present disclosure.

FIG. 7 is a timing diagram illustrating measurement resource sharing for a partially overlapped example with a plurality of MGs per MGRP in accordance with some aspects of the present disclosure.

FIG. 8 is a flow diagram for a UE configured to perform measurement resource sharing in accordance with some aspects of the present disclosure.

FIG. 9 is a flow diagram for a UE configured to perform measurement resource sharing in accordance with some aspects of the present disclosure.

FIG. 10 is a flow diagram as a continuation of the flow diagram of FIG. 9 for a UE configured to perform measurement resource sharing in accordance with some aspects of the present disclosure.

FIG. 11 is a flow diagram as a continuation of the flow diagram of FIG. 9 for a UE configured to measurement resource sharing in accordance with some aspects of the present disclosure.

FIG. 12 is a flow diagram as a continuation of the flow diagram of FIG. 9 for a UE configured to perform measurement resource sharing in accordance with some aspects of the present disclosure.

FIG. 13 is a flow diagram as a continuation of the flow diagram of FIG. 9 for a UE configured to perform measurement resource sharing in accordance with some aspects of the present disclosure.

FIG. 14 is a timing diagram illustrating an example of fair distribution of measurement resources in accordance with some aspects of the present disclosure.

FIG. 15 is a timing diagram illustrating an example of fair distribution of measurement resources in accordance with some aspects of the present disclosure.

FIG. 16 is a timing diagram illustrating an example measurement resource sharing sequence in relation to Option 1 discussed with respect to FIG. 5.

FIG. 17 is a timing diagram illustrating an example measurement resource sharing sequence in relation to FIG. 6.

FIG. 18 is a block diagram illustrating a wireless communication system including a UE device and a network device in accordance with some aspects of the present disclosure.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Wireless communications are affected by spatial relationships between a UE and a BS with which the UE is communicating, as well as spatial relationships with respect to other BSs and other environmental objects and conditions. Phenomena such as noise, interference, and attenuation can vary over time and affect signals being communicated. A UE can perform measurements to assess attributes of signals and report measurement results to the BS. The UE and the BS can use the information from measurements to support UE operation such as cell selection/reselection or beam management, and thus to improve quality of service. As an example, in 5G, synchronization signal blocks (SSBs) are used to determine path loss and average channel quality. Channel Status Information reference signal (CSI-RS) are used for tracking rapidly changing channel conditions to support mobility and beam management. Some examples of UE measurements include reference signal received power (RSRP), reference signal received quality (RSRQ), and signal to interference and noise ratio (SINR) measurements.

UE measurements can involve changes to operational parameters of a transceiver of the UE, such as changing a frequency range to which the transceiver is tuned. For example, if communications are being provided over a first frequency range, and the UE is to measure synchronization or reference signals in a second frequency range, the UE may need a measurement gap (MG) to retune the UE's transceiver to the second frequency range and perform the measurement. The MG may be scheduled to occur repetitively, for example, during each measurement gap repetition period (MGRP). In some aspects, more than one MGs, such as two MGs, which may be labelled MG1, MG2, may each have a pattern and occur repetitively within the same MGRP, such that MG1 may recur during each MGRP and MG2 may recur during the same MGRP.

On the other hand, since MGs correspond to periods at which transmission and reception of data on at least one frequency band are suspended in order to, in some instances, conduct measurements on a different frequency band, MGs reduce transmit/receive efficiency. Therefore, a continuing goal in wireless communication is to reduce or eliminate MGs. In some cases, gapless UE measurements can be applied, for example, by using inactive RF resources correspond to an RF chain and baseband circuitry for a secondary cell group (SCG) when carrier aggregation is disabled or otherwise off. For example, intra-frequency synchronization signal block (SSB) measurement timing configuration (SMTC) measurements may be performed without using measurement gaps. However, depending on the timing of MGs and gapless measurements, a conflict may arise, preventing a UE from performing both a measurement in a MG and a gapless measurement in close temporal proximity.

In view of the above, a method and apparatus for measurement resource sharing are provided. In some aspects, a UE is configured to, determine, for a period of time at least as long as a measurement gap repetition period (MGRP), if all SMTC occasions are within less than an temporal proximity threshold of any of one or more measurement gap (MG) occasions. When all of the SMTC occasions are within less than the temporal proximity threshold of any of the MG occasions, the UE is configured to allocate measurement resources based on a sharing scheme, as specified in more details below, among gapless measurements during a subset of the SMTC occasions and other measurement objects during a subset of the one or more MG occasions. When not all of the SMTC occasions are within less than the temporal proximity threshold of any of the MG occasions, the UE is configured, for the period of time, to determine if any of the SMTC occasions are within less than the temporal proximity threshold of any of the one or more MG occasions. When any of the SMTC occasions are within less than the temporal proximity threshold of any of the MG occasions, the UE is configured to allocate non-overlapped SMTC occasions of the SMTC occasions to be used for gapless measurements, inhibiting use of overlapped SMTC occasions, and allocating the MG occasions to be used for measurement of the other measurement objects.

Additional aspects and details of the disclosure are further described below with reference to figures.

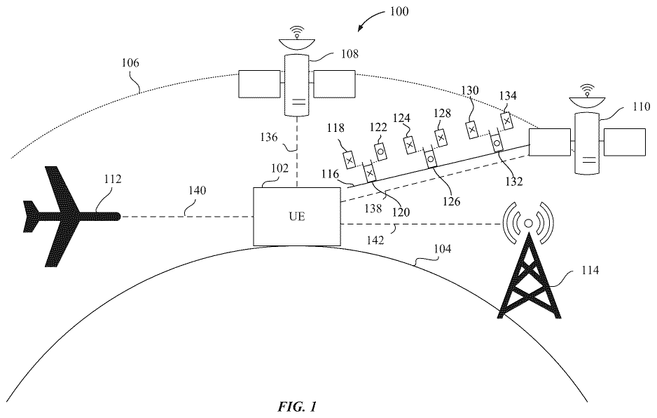

FIG. 1 is a block diagram illustrating a wireless network including a user equipment (UE) and a base station, with the UE implementing a measurement resource sharing scheme in accordance with some aspects of the present disclosure. Wireless network 100 comprises UE 102, BS 108, BS 110, BS 112, and BS 114. As shown, BS 108 can, for example, be a satellite in orbit 106 or another spaceborne platform providing a non-terrestrial network (NTN), such as a satellite access network (SAN), or another type of BS platform. UE 102 can communicate with BS 108 via path 136. As shown, BS 110 can, for example, be another satellite in the orbit 106 or another orbit or another spaceborne platform providing a NTN, such as a SAN, or another type of BS platform. UE 102 can communicate with BS 110 via path 138. As shown, BS 112 can, for example, be an airborne platform, such as an airplane, a helicopter, a balloon, another type of atmospheric platform, or another type of BS platform. UE 102 can communicate with BS 112 via path 140. As shown, BS 114 can, for example, be a terrestrial BS or another type of BS platform. UE 102 can communicate with BS 114 via path 142.

UE 102 is shown as being a terrestrial UE based on Earth 104, or UE 102 can be located elsewhere, such as in an aircraft. One example of UE 102 being situated in an aircraft can be in an air-to-ground situation, where the aircraft may communicate with a ground-based BS. Another example of UE 102 being situated in an aircraft can be in an air-to-air or air-to-spec situation, where the aircraft may communicate with a BS instantiated as an airborne or spaceborne platform.

A UE may be located at varying distances from a BS. In some aspects, a UE can be located far from a terrestrial UE. As an example, a BS may provide long distance coverage over a large area of low user density. As another example, an airborne UE may operate in an air-to-ground situation over a long distance. Communication of a UE with a BS instantiated as an airborne or spaceborne platform can involve long distances. Moreover, relative motion between a UE and a BS can change the propagation delay of a signal being communicated, which can change the timing of reception of the signal. The timing domain of one BS may be different than the timing domain of another BS, which may complicate coordination of timing for measurements of signals from different BSs. Timing conflicts for measurements of different signals, also referred as colliding, can arise not only with signals that are temporally overlapping but also with signals that are temporally proximate within a temporal proximity threshold.

UE 102 can tentatively configure a plurality of MG occasions 120, 126, and 132 and a plurality of gapless measurement occasions 118, 122, 124, 128, 130, and 134 over time 116 for performing measurements with respect to one or more BSs, such as BS 110 via path 138. The plurality of gapless measurement occasions may be for an intra-frequency synchronization signal block (SSB) based measurement timing configuration (SMTC) measurement. In cases where all of the plurality of gapless measurement occasions are determined as colliding with at least one of the plurality of MG occasions, the plurality of gapless measurement occasions is considered as fully overlapped, and needs to share measurement resources with the plurality of MG occasions. Then some MG occasions are inhibited from use so the gapless measurement can be performed. For example, as shown in FIG. 1, MG occasion 120 is marked with X to denote inhibition of use of MG occasion 120 for measurement due to a conflict with a temporally proximate gapless measurement occasion, such as gapless measurement occasions 118 and 122. As shown, MG occasions 126 and 132 are marked with O to denote availability of use of MG occasions 126 and 132 for measurements. As shown, gapless measurement occasion 118 is marked with X to denote inhibition of use of gapless measurement occasion 118 for measurement due to a conflict with a temporally proximate MG occasion, such as MG occasion 120. As shown, gapless measurement occasion 122 is marked O to denote availability of use of gapless measurement occasion 122 for measurement even though gapless measurement occasion 122 may be temporally proximate to MG occasion 120, as the inhibition of MG occasion 120 allows gapless measurement occasion 122 to be used for measurement without contention.

As shown, gapless measurement occasions 124 and 128 are marked X to denote inhibition of use of gapless measurement occasions 124 and 128 for measurements due to conflicts with a temporally proximate MG occasion, such as MG occasion 126. As gapless measurement occasions 124 and 128 are shown to be inhibited from use, MG occasion 126 is available for use without contention despite its temporal proximity to gapless measurement occasions 124 and 128.

As shown, gapless measurement occasions 130 and 134 are marked X to denote inhibition of use of gapless measurement occasions 130 and 134 for measurements due to conflicts with a temporally proximate MG occasion, such as MG occasion 132. As gapless measurement occasions 130 and 134 are shown to be inhibited from use, MG occasion 132 is available for use without contention despite its temporal proximity to gapless measurement occasions 130 and 134. Accordingly, measurement resource sharing is provided to accommodate both gapless measurements and gap based measurements while conforming to constraints, such as a limitation imposed by a temporal proximity threshold.

As an example, UE 102 can, for a period of time at least as long as a measurement gap repetition period (MGRP), determine if all synchronization signal block (SSB) measurement timing configuration (SMTC) occasions are within less than an temporal proximity threshold of any of one or more measurement gap (MG) occasions. When all of the SMTC occasions are within less than the temporal proximity threshold of any of the MG occasions, UE 102 can allocate measurement resources to provide equal sharing among gapless measurements during a subset of the SMTC occasions and other measurement objects during a subset of the one or more MG occasions. UE 102 can, for the period of time, determine if any but not all of the SMTC occasions are within less than the temporal proximity threshold of any of the one or more MG occasions. When any but not all of the SMTC occasions are within less than the temporal proximity threshold of any of the MG occasions, UE 102 can allocate non-overlapped SMTC occasions of the SMTC occasions to be used for gapless measurements, inhibiting use of overlapped SMTC occasions, and allocating the MG occasions to be used for measurement of the other measurement objects.

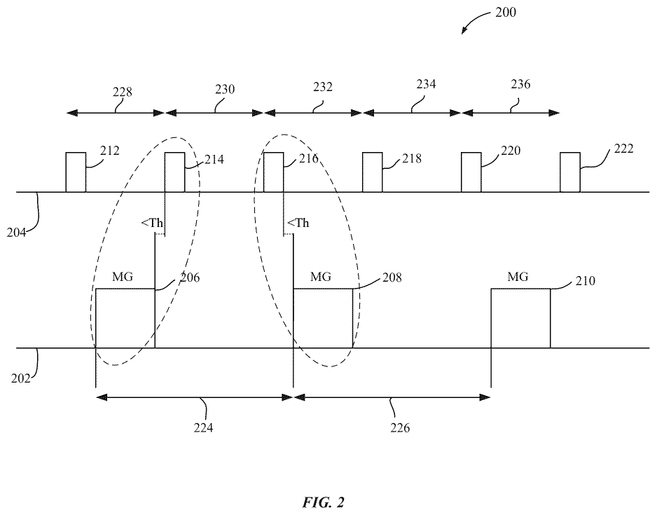

FIG. 2 is a timing diagram illustrating a measurement resource sharing for a fully overlapped example in accordance with some aspects of the present disclosure. Measurement sharing scheme 200 of a UE, such as UE 102 of FIG. 1, is shown along time axis 202 for MGs occasions and along time axis 204, temporally aligned with time axis 202, for gapless measurement occasions. MGs 206, 208, and 210 are depicted along time axis 202. MG 206 is situated in MGRP 224, and MG 208 is situated in MGRP 226. A MGRP may have a duration of a specified period of time, for example, 20, 40, 80, or 160 milliseconds. A MG may have a duration, referred to as a measurement gap length (MGL) of a specified period of time, for example, 1.5, 3, 3.5, 4, 5.5, 6, 10, or 20 milliseconds. In the depicted example, MGRP 224 and MGRP 226 are shown to have durations of 20 milliseconds, and MG 206, MG 208, and MG 210 are shown to have MGLs of 6 milliseconds. Gapless measurement occasions 212, 214, 216, 218, 220, and 222 are depicted along time axis 204. Gapless measurement occasion 212 is situated in gapless measurement repetition period 228. Gapless measurement occasion 214 is situated in gapless measurement repetition period 230. Gapless measurement occasion 216 is situated in gapless measurement repetition period 232. Gapless measurement occasion 218 is situated in gapless measurement repetition period 234. Gapless measurement occasion 220 is situated in gapless measurement repetition period 236. A gapless measurement repetition period may have a duration of a specified period of time, for example, 5, 10, 20, 40, 80, or 160 milliseconds. A gapless measurement occasion may have a duration of a specified period of time, for example, 1, 2, 3, 4, or 5 milliseconds. In the depicted example, gapless measurement repetition periods 228, 230, 232, 234, and 236 are shown to have durations of 10 milliseconds, and gapless measurement durations are shown to have durations of 2 milliseconds. With the examples of MGRPs of 20 milliseconds and gapless measurement repetition periods of 10 milliseconds, gapless measurement occasions occur twice as frequently as MG occasions, so, for over a given time, there are twice as many gapless measurement occasions as MG occasions. Such ratios can vary in different implementations, as will be shown by different examples further below. The temporal position of a gapless measurement occasion may or may not be temporally aligned with a MG. If a gapless measurement occasion is situated outside a MG, it may or may not be within a temporal proximity threshold of the MG, such as the leading or trailing edge of a MG. A temporal proximity threshold may have a specified value, for example, 4 milliseconds.

The relationships of the gapless measurement occasions and the MG occasions shown in FIG. 2 are, in that example, within the temporal proximity threshold of each other, so contention exists throughout the sequences of each. By taking into account the absence of temporal spacing of at least the temporal proximity threshold, the gapless measurement occasions and MG occasions of FIG. 2 can be said to be fully overlapped. In such case, a scaling factor Kp for measurement resource sharing is defined as equal to 1, and the gapless measurement occasions equally share the measurement resource with other MG occasions.

Measurement resource sharing can be implemented as described below. It can be observed that the gapless measurement period is less than the MGRP. Within each MGRP, for each gapless measurement occasion, the UE can find the MG occasion situated closest in time to that gapless measurement occasion. The UE can apply a temporal proximity rule (e.g., comparison to the temporal proximity threshold) to determine if the gapless measurement occasion is overlapped with the MG occasion or not. If all of the gapless measurement occasions within the MGRP are determined to be overlapping (e.g., conflicting, including when the temporal proximity rule is applied) with the closest MG occasion, the relationship of the gapless measurement occasions to the MG occasions is deemed to be fully overlapped. The UE can arrange for a gapless measurement (e.g., an intra-frequency measurement object (MO)) associated with the gapless measurement occasion (rather than with a MG) to equally share the measurement resource with other measurements (e.g., inter-frequency and intra-frequency MOs), which may be associated with a MG occasion. An instance of contention between a gapless measurement occasion and a MG occasion may be resolved by granting use of the gapless measurement occasion for gapless measurement and inhibiting use of the temporally proximate MG occasion. A different instance of contention between a gapless measurement occasion and a MG occasion may be resolved by granting use of the MG occasion for gap based measurement and inhibiting use of the temporally proximate gapless measurement occasion. By granting and inhibiting use of gapless measurement occasions and MG occasions for measurements in appropriate proportions (e.g., a round-robin sequence), a fair allocation of measurement resources for different types of measurements can be provided.

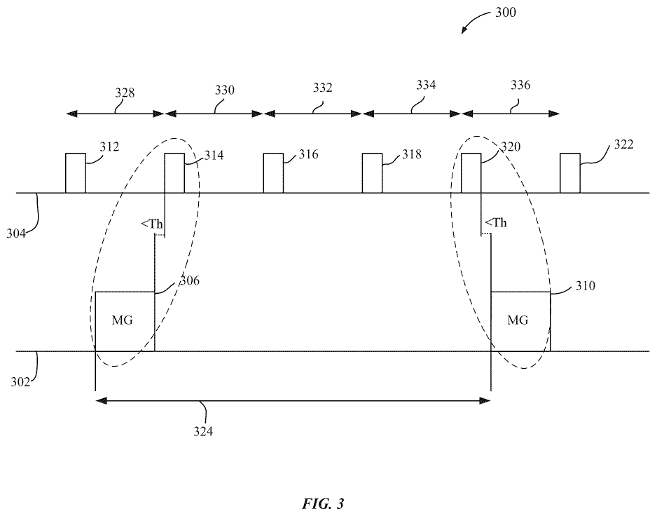

FIG. 3 is a timing diagram illustrating measurement resource sharing for a partially overlapped example in accordance with some aspects of the present disclosure. Measurement sharing scheme 300 of a UE, such as UE 102 of FIG. 1, is shown along time axis 302 for MGs occasions and along time axis 304, temporally aligned with time axis 302, for gapless measurement occasions. MGs 306 and 310 are depicted along time axis 302. MG 306 is situated in MGRP 324. In the depicted example, MGRP 324 is shown to have a duration of 40 milliseconds, and MG 306 and MG 310 are shown to have MGLs of 6 milliseconds. Gapless measurement occasions 312, 314, 316, 318, 320, and 322 are depicted along time axis 304. Gapless measurement occasion 312 is situated in gapless measurement repetition period 328. Gapless measurement occasion 314 is situated in gapless measurement repetition period 330. Gapless measurement occasion 316 is situated in gapless measurement repetition period 332. Gapless measurement occasion 318 is situated in gapless measurement repetition period 334. Gapless measurement occasion 320 is situated in gapless measurement repetition period 336. In the depicted example, gapless measurement repetition periods 328, 330, 332, 334, and 336 are shown to have durations of 10 milliseconds, and gapless measurement durations are shown to have durations of 2 milliseconds. With the examples of MGRPs of 40 milliseconds and gapless measurement repetition periods of 10 milliseconds, gapless measurement occasions occur four times as frequently as MG occasions, so, for over a given time, there are four times as many gapless measurement occasions as MG occasions. Such ratios can vary in different implementations. A temporal proximity threshold may have a specified value, for example, 4 milliseconds.

The relationships of the gapless measurement occasions and the MG occasions shown in FIG. 3 include, in that example, some, such as gapless measurement occasions 312 and 314 and MG occasion 306, as well as gapless measurement occasions 320 and 322 and MG occasion 310, which are within the temporal proximity threshold of each other, with contention existing between them, and others, such as gapless measurement occasions 316 and 318, which are not within the temporal proximity threshold of any MG occasion. Since some measurement occasions are overlapped and some are not, where overlapping includes presence within an amount of time less than the temporal proximity threshold, the gapless measurement occasions and MG occasions of FIG. 3 can be said to be partially overlapped. In such cases, a scaling factor Kp for the measurement resource sharing is defined as X/Y, where Y is the total number of SMTC occasions within the MGRP, including those overlapped and not-overlapped with measurement gap occasions within the MGRP based on proximity rule, and X is the number of SMTC occasions that are not overlapped with any MG occasion within the MGRP (which not meet the proximity rule). In the example of FIG. 3, the total number Y of SMTC occasions within the MGRP 324 equals to 4, and the number X of SMTC occasions that are not overlapped with any MG occasion within the MGRP 324 equals to 2, and thus the scaling factor Kp for the example of FIG. 3 is defined as X/Y=2/4=0.5.

Measurement resource sharing can be implemented as described below. It can be observed that the gapless measurement period is less than the MGRP. Within each MGRP, for each gapless measurement occasion, the UE can find the MG occasion situated closest in time to that gapless measurement occasion. The UE can apply a temporal proximity rule (e.g., comparison to the temporal proximity threshold) to determine if the gapless measurement occasion is overlapped with the MG occasion or not. Since some but not all of the gapless measurement occasions within the MGRP are determined to be overlapping (e.g., conflicting, including when the temporal proximity rule is applied) with the closest MG occasion, the relationship of the gapless measurement occasions to the MG occasions is deemed to be partially overlapped. The UE can arrange for a gapless measurement (e.g., an intra-frequency measurement object (MO)) associated with a gapless measurement occasion (rather than with a MG) to be performed in the gapless measurement occasion under the condition that the gapless measurement occasion is non-overlapped with any MG occasion. The UE can inhibit gapless measurement in the gapless measurement occasions which are overlapped with any MG occasion (including any temporal distance of less than the temporal proximity threshold preceding or following any MG occasion). The UE can enable gap based measurement to be performed in those MG occasions for which temporally proximate gapless measurement occasions are inhibited. Accordingly, the UE can allow gapless measurements (e.g., an intra-frequency MO (without a MG)) to be performed and also allow other measurements (e.g., inter-frequency and intra-frequency MOs) associated with a MG occasion to be performed. An instance of contention between a gapless measurement occasion and a MG occasion may be resolved by granting use of the MG occasion for gap based measurement and inhibiting use of the temporally proximate gapless measurement occasion, as other gapless measurement occasions without contention are available for gapless measurement in the partially overlapped case. By granting and inhibiting use of gapless measurement occasions and MG occasions for measurements in appropriate proportions (e.g., a round-robin sequence), a fair allocation of measurement resources for different types of measurements can be provided.

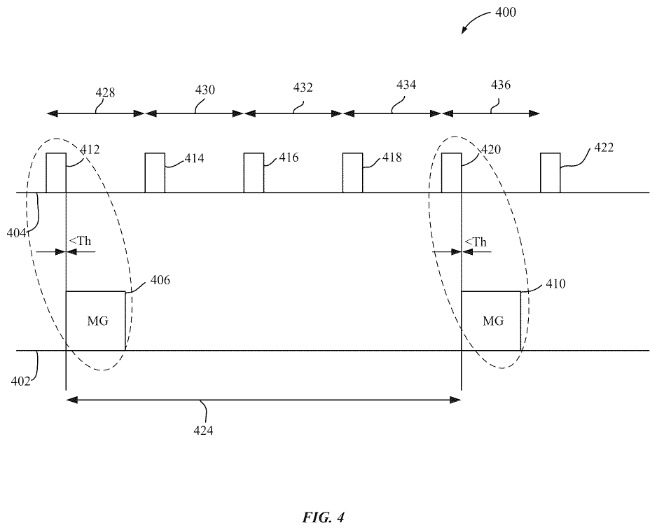

FIG. 4 is a timing diagram illustrating measurement resource sharing for a partially overlapped example in accordance with some aspects of the present disclosure. Measurement sharing scheme 400 of a UE, such as UE 102 of FIG. 1, is shown along time axis 402 for MGs occasions and along time axis 404, temporally aligned with time axis 402, for gapless measurement occasions. MGs 406 and 410 are depicted along time axis 402. MG 406 is situated in MGRP 424. In the depicted example, MGRP 424 is shown to have a duration of 40 milliseconds, and MG 406 and MG 410 are shown to have MGLs of 6 milliseconds. Gapless measurement occasions 412, 414, 416, 418, 420, and 422 are depicted along time axis 404. Gapless measurement occasion 412 is situated in gapless measurement repetition period 428. Gapless measurement occasion 414 is situated in gapless measurement repetition period 430. Gapless measurement occasion 416 is situated in gapless measurement repetition period 432. Gapless measurement occasion 418 is situated in gapless measurement repetition period 434. Gapless measurement occasion 420 is situated in gapless measurement repetition period 436. In the depicted example, gapless measurement repetition periods 428, 430, 432, 434, and 436 are shown to have durations of 10 milliseconds, and gapless measurement durations are shown to have durations of 2 milliseconds. With the examples of MGRPs of 40 milliseconds and gapless measurement repetition periods of 10 milliseconds, gapless measurement occasions occur four times as frequently as MG occasions, so, for over a given time, there are four times as many gapless measurement occasions as MG occasions. Such ratios can vary in different implementations. A temporal proximity threshold may have a specified value, for example, 4 milliseconds.

The relationships of the gapless measurement occasions and the MG occasions shown in FIG. 4 include, in that example, some, such as gapless measurement occasion 412 and MG occasion 406, as well as gapless measurement occasions 420 and MG occasion 410, which are within the temporal proximity threshold of each other, with contention existing between them, and others, such as gapless measurement occasions 414, 416, 418, and 422 which are not within the temporal proximity threshold of any MG occasion. Thus, FIG. 4 differs from FIG. 3 in that gapless measurement occasion 414 is not within the temporal proximity threshold of (i.e., not overlapped with) MG occasion 406 and gapless measurement occasion 422 is not within the temporal proximity threshold of (i.e., not overlapped with) MG occasion 410, whereas, in the example of FIG. 3, gapless measurement occasion 314 is within the temporal proximity threshold of (i.e., overlapped with) MG occasion 306 and gapless measurement occasion 322 is within the temporal proximity threshold of (i.e., overlapped with) MG occasion 310. Since, in the example of FIG. 4, some measurement occasions are overlapped and some are not, where overlapping includes presence within an amount of time less than the temporal proximity threshold, the gapless measurement occasions and MG occasions of FIG. 4 can be said to be partially overlapped. In such cases, a scaling factor Kp for the measurement resource sharing is defined as X/Y, where Y is the total number of SMTC occasions within the MGRP, including those overlapped and not-overlapped with measurement gap occasions within the MGRP based on proximity rule, and X is the number of SMTC occasions that are not overlapped with any MG occasion within the MGRP (which not meet the proximity rule). In the example of FIG. 4, the total number Y of SMTC occasions within the MGRP 424 equals to 4, and the number X of SMTC occasions that are not overlapped with any MG occasion within the MGRP 424 equals to 3, and thus the scaling factor Kp for the example of FIG. 4 is defined as X/Y=3/4=0.75.

Measurement resource sharing can be implemented as described below. It can be observed that the gapless measurement period is less than the MGRP. Within each MGRP, for each gapless measurement occasion, the UE can find the MG occasion situated closest in time to that gapless measurement occasion. The UE can apply a temporal proximity rule (e.g., comparison to the temporal proximity threshold) to determine if the gapless measurement occasion is overlapped with the MG occasion or not. Since some but not all of the gapless measurement occasions within the MGRP are determined to be overlapping (e.g., conflicting, including when the temporal proximity rule is applied) with the closest MG occasion, the relationship of the gapless measurement occasions to the MG occasions is deemed to be partially overlapped. The UE can arrange for a gapless measurement (e.g., an intra-frequency measurement object (MO)) associated with a gapless measurement occasion (rather than with a MG) to be performed in the gapless measurement occasion under the condition that the gapless measurement occasion is non-overlapped with any MG occasion. The UE can inhibit gapless measurement in the gapless measurement occasions which are overlapped with any MG occasion (including any temporal distance of less than the temporal proximity threshold preceding or following any MG occasion). The UE can enable gap based measurement to be performed in those MG occasions for which temporally proximate gapless measurement occasions are inhibited. Accordingly, the UE can allow gapless measurements (e.g., an intra-frequency MO (without a MG)) to be performed and also allow other measurements (e.g., inter-frequency and intra-frequency MOs) associated with a MG occasion to be performed. An instance of contention between a gapless measurement occasion and a MG occasion may be resolved by granting use of the MG occasion for gap based measurement and inhibiting use of the temporally proximate gapless measurement occasion, as other gapless measurement occasions without contention are available for gapless measurement in the partially overlapped case. By granting and inhibiting use of gapless measurement occasions and MG occasions for measurements in appropriate proportions (e.g., a round-robin sequence), a fair allocation of measurement resources for different types of measurements can be provided.

FIG. 5 is a timing diagram illustrating measurement resource sharing for a fully overlapped example with a plurality of measurement gaps (MGs) per measurement gap repetition period (MGRP) in accordance with some aspects of the present disclosure.

Measurement sharing scheme 500 of a UE, such as UE 102 of FIG. 1, is shown along time axis 502 for MGs occasions and along time axis 504, temporally aligned with time axis 502, for gapless measurement occasions. MGs 506, 508, and 510 are depicted along time axis 502. MG 506 and MG 508 are situated in MGRP 524, with MG 506 being denoted as MG1 and MG 508 being denoted as MG2. MG1 and MG2 repeat in each successive MGRP, as can be seen by MG 510 being the instance of MG1 situated in the MGRP following MGRP 524. In the depicted example, MGRP 524 is shown to have a duration of 40 milliseconds, and MG 506, MG 508, and MG 510 are shown to have MGLs of 6 milliseconds. Gapless measurement occasions 512, 516, and 520 are depicted along time axis 504. Gapless measurement occasion 512 is situated in gapless measurement repetition period 528. Gapless measurement occasion 516 is situated in gapless measurement repetition period 532. In the depicted example, gapless measurement repetition periods 528 and 532 are shown to have durations of 20 milliseconds, and gapless measurement durations are shown to have durations of 2 milliseconds. With the examples of MGRPs of 40 milliseconds and gapless measurement repetition periods of 20 milliseconds, gapless measurement repetition periods occur twice as frequently as MGRPs, but, since there are two MGs per MGRP, over a given time, there are equal numbers of gapless measurement occasions and MG occasions. Such ratios can vary in different implementations. The temporal position of a gapless measurement occasion may or may not be temporally aligned with a MG. If a gapless measurement occasion is situated outside a MG, it may or may not be within a temporal proximity threshold of the MG, such as the leading or trailing edge of a MG. A temporal proximity threshold may have a specified value, for example, 4 milliseconds.

The relationships of the gapless measurement occasions and the MG occasions shown in FIG. 5 are, in that example, within the temporal proximity threshold of each other, as shown by dashed lines, so contention exists throughout the sequences of each. By taking into account the absence of temporal spacing of at least the temporal proximity threshold, the gapless measurement occasions and MG occasions of FIG. 5 can be said to be fully overlapped. Note that, in that example, MG occasion 506 (MG1) and MG occasion 508 (MG2) are separated from each other by a time of at least the temporal proximity threshold, so there is no contention between MG1 and MG2 within MGRP 524, but the temporal proximity of gapless measurement occasion 512 to MG occasion 506 and the temporal proximity of gapless measurement occasion 516 to MG occasion 508 still result in FIG. 5 being a fully overlapped example. In such case, a scaling factor Kp for measurement resource sharing is defined as equal to 1, and the gapless measurement occasions equally share the measurement resource with other MG occasions.

Measurement resource sharing can be implemented as described below. It can be observed that the gapless measurement period is less than the MGRP. Within each MGRP, for each gapless measurement occasion, the UE can find the MG occasion situated closest in time to that gapless measurement occasion. The UE can apply a temporal proximity rule (e.g., comparison to the temporal proximity threshold) to determine if the gapless measurement occasion is overlapped with the MG occasion or not. If all of the gapless measurement occasions within the MGRP are determined to be overlapping (e.g., conflicting, including when the temporal proximity rule is applied) with the closest MG occasion, the relationship of the gapless measurement occasions to the MG occasions is deemed to be fully overlapped. The UE can arrange for a gapless measurement (e.g., an intra-frequency measurement object (MO)) associated with the gapless measurement occasion (rather than with a MG) to equally share the measurement resource with other measurements (e.g., inter-frequency and intra-frequency MOs), which may be associated with a MG occasion. An instance of contention between a gapless measurement occasion and a MG occasion may be resolved by granting use of the gapless measurement occasion for gapless measurement and inhibiting use of the temporally proximate MG occasion. A different instance of contention between a gapless measurement occasion and a MG occasion may be resolved by granting use of the MG occasion for gap based measurement and inhibiting use of the temporally proximate gapless measurement occasion. By granting and inhibiting use of gapless measurement occasions and MG occasions for measurements in appropriate proportions (e.g., a round-robin sequence), a fair allocation of measurement resources for different types of measurements can be provided. As one example, a fair sequence can include inhibiting MG1 and MG2 occasions in one MGRP (e.g., MG occasion 506 and MG occasion 508 in MGRP 524) to allow use of corresponding temporally proximate gapless measurement occasions (e.g., gapless measurement occasions 512 and 516) to be used for gapless measurements and inhibiting temporally proximate gapless measurement occasions (e.g., gapless measurement occasion 520) in a subsequent MGRP to allow use of MG1 and MG2 occasions (e.g., MG occasion 510 and a following MG2 occasion) in the subsequent MGRP for gap based measurement. The sequence of gapless and gap based measurements can be continued in subsequent MGRPs. As another example, a fair sequence can include inhibiting a gapless measurement occasion temporally proximate to either a MG1 or MG2 occasion in one MGRP, using the corresponding MG1 or MG2 occasion for gap based measurement, inhibiting the opposite one of the MG1 and MG2 occasions in that MGRP and using the gapless measurement occasion temporally proximate to it for gapless measurement, then, in another MGRP, doing the same but with respect to the opposites of the MG1 and MG2 occasions to allow gap based measurements for both MG1 and MG2 and gapless measurements across multiple MGRPs.

In some aspects, as illustrated by the example of FIG. 5, for a multiple MG per MGRP scenario (e.g., a dual MG per MGRP scenario, such as where two distinct MG patterns are configured, for example, for a NTN situation), the following acts can be performed, for example, by a UE:

A window is determined as max(SMTC period, max MGRP), where max MGRP is the maximum MGRP across all configured per-UE measurement gap and/or per frequency range (per-FR) measurement gap within the same FR as the SSB frequency layer, and starting from the beginning of any SMTC occasion. Since the MGRP 524 is of greater duration than gapless measurement repetition periods 528 and 532, the window of FIG. 5 is determined to start at the beginning of gapless measurement occasion 512 and to extend a duration equal to the duration of MGRP 524 to the beginning of gapless measurement occasion 520, spanning gapless measurement repetition periods 528 and 532, since ratio of the duration of MGRP 524 to the duration of gapless measurement repetition periods 528 and 532 is, in this example, 2:1.

The UE can find, for each SMTC occasion, the closest MG occasion to the SMTC occasion. In the example of FIG. 5, for gapless measurement occasion 512, the closest MG occasion is determined to be MG occasion 506. The UE can use a temporal proximity rule to determine if the SMTC is overlapped with the closest MG or not. In the example of FIG. 5, MG occasion 506 is closer than a temporal proximity threshold of the temporal proximity rule to gapless measurement occasion 512. If all SMTCs inside this window are determined to be colliding with their respective closest MG, but the MGs are not colliding with each other, such case will be treated as a fully overlapped case with the measurement resource sharing scaling factor Kp=1. In the example of FIG. 5, as shown by the dashed ellipses and the “<Th” notations, all gapless measurement occasions inside the window are determined to be colliding with their respective closest MG, and, as shown by the “>Th” notation between gapless measurement occasions 506 and 508, the MGs are not colliding with each other, so the example of FIG. 5 will be treated as a fully overlapped case with the measurement resource sharing scaling factor Kp=1. The intra-frequency measurement object (MO) (without MG) associated with this SMTC can share the measurement resource with other inter-frequency and intra-frequency MOs (with MGs) based on following options, with MG1 associated with m1 MOs and MG2 associated with m2 MOS:
Option 1: the intra-frequency MO (without MG) associated with this SMTC will occupy 1/(max(m1,m2)+1), and the total measurement period based on this SMTC would be extended by (max(m1,m2)+1). As an example in the context of FIG. 5, if MG1 is used for measurements for two MOs and MG2 is used for measurements for three MOs, then Option 1 would yield a result of gapless measurements being made in 1/(3+1)=¼ of the gapless measurement occasions, and the total measurement period would be extended to 3+1=4 times the amount of time that would have been used if gapless measurements could have been made in all gapless measurement occasions. Since, in FIG. 5, MG occasion 506 and MG occasion 508 do not conflict with each other, both can be used for measuring according to their respective MOs, so at least one measurement for each MO of both MG1 and MG2 can be made between allowances of gapless measurements when using Option 1.
Option 2: the intra-frequency MO (without MG) associated with this SMTC will occupy 1/(min(m1,m2)+1), and the total measurement period based on this SMTC would be extended by (min(m1,m2)+1). As an example in the context of FIG. 5, if MG1 is used for measurements for two MOs and MG2 is used for measurements for three MOs, then Option 2 would yield a result of gapless measurements being made in 1/(2+1)=⅓ of the gapless measurement occasions, and the total measurement period would be extended to 2+1=3 times the amount of time that would have been used if gapless measurements could have been made in all gapless measurement occasions.
Option 3: the intra-frequency MO (without MG) associated with this SMTC will occupy 1/((m1+m2)+1), and the total measurement period based on this SMTC would be extended by ((m1+m2)+1). As an example in the context of FIG. 5, if MG1 is used for measurements for two MOs and MG2 is used for measurements for three MOs, then Option 1 would yield a result of gapless measurements being made in 1/(5+1)=⅙ of the gapless measurement occasions, and the total measurement period would be extended to 5+1=6 times the amount of time that would have been used if gapless measurements could have been made in all gapless measurement occasions.
Option 4: if N SMTC are needed for measurement, the total measurement period based on this SMTC would be extended to (N/2)*(m1+1)+(N/2)*(m2+1), if N is even number, and the total measurement period based on this SMTC would be extended to ((N+1)/2)*(m1+1)+((N−1)/2)*(m2+1) or ((N−1)/2)*(m1+1)+((N+1)/2)*(m2+1), if N is odd number. As an example in the context of FIG. 5, if MG1 is used for measurements for two MOs and MG2 is used for measurements for three MOs, and 5 gapless (e.g., SMTC) measurements are needed, then Option 4 would yield a result of gapless measurements being made in 1/(5+1)=⅙ of the gapless measurement occasions, and the total measurement period would be extended to ((5+1)/2)*(2+1)+((5−1)/2)*(3+1)=3*3+2*4=9+8=17 or ((5−1)/2)*(2+1)+((5+1)/2)*(3+1)=2*3+3*4=6+12=18 times the amount of time that would have been used if gapless measurements could have been made in all gapless measurement occasions.

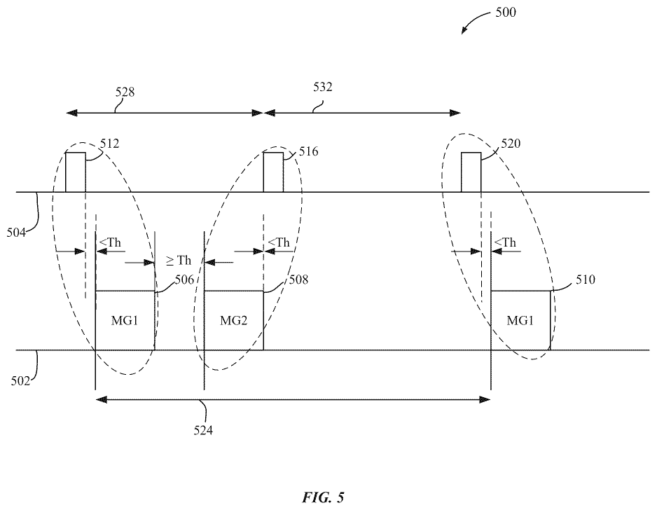

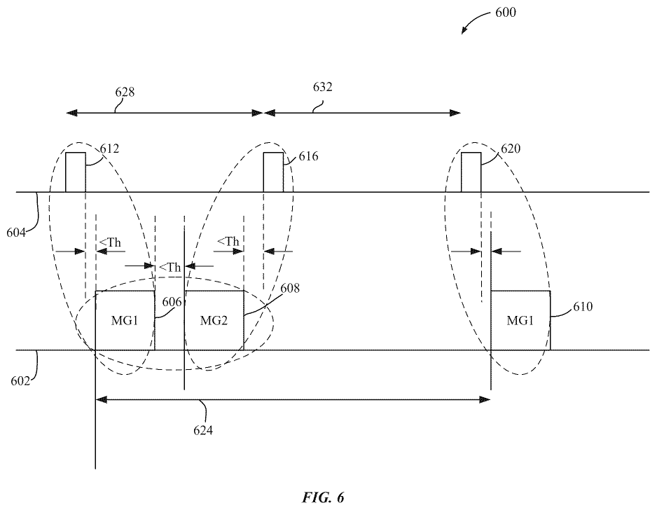

FIG. 6 is a timing diagram illustrating measurement resource sharing for a fully overlapped example with a plurality of MGs per MGRP in accordance with some aspects of the present disclosure. Measurement sharing scheme 600 of a UE, such as UE 102 of FIG. 1, is shown along time axis 602 for MGs occasions and along time axis 604, temporally aligned with time axis 602, for gapless measurement occasions. MGs 606, 608, and 610 are depicted along time axis 602. MG 606 and MG 608 are situated in MGRP 624, with MG 606 being denoted as MG1 and MG 608 being denoted as MG2. MG1 and MG2 repeat in each successive MGRP, as can be seen by MG 610 being the instance of MG1 situated in the MGRP following MGRP 624. In the depicted example, MGRP 624 is shown to have a duration of 40 milliseconds, and MG 606, MG 608, and MG 610 are shown to have MGLs of 6 milliseconds. Gapless measurement occasions 612, 616, and 620 are depicted along time axis 604. Gapless measurement occasion 612 is situated in gapless measurement repetition period 628. Gapless measurement occasion 616 is situated in gapless measurement repetition period 632. In the depicted example, gapless measurement repetition periods 628 and 632 are shown to have durations of 20 milliseconds, and gapless measurement durations are shown to have durations of 2 milliseconds. With the examples of MGRPs of 40 milliseconds and gapless measurement repetition periods of 20 milliseconds, gapless measurement repetition periods occur twice as frequently as MGRPs, but, since there are two MGs per MGRP, over a given time, there are equal numbers of gapless measurement occasions and MG occasions. Such ratios can vary in different implementations. The temporal position of a gapless measurement occasion may or may not be temporally aligned with a MG. If a gapless measurement occasion is situated outside a MG, it may or may not be within a temporal proximity threshold of the MG, such as the leading or trailing edge of a MG. A temporal proximity threshold may have a specified value, for example, 4 milliseconds.

The relationships of the gapless measurement occasions and the MG occasions shown in FIG. 6 are, in that example, within the temporal proximity threshold of each other, as shown by dashed lines, so contention exists throughout the sequences of each. By taking into account the absence of temporal spacing of at least the temporal proximity threshold, the gapless measurement occasions and MG occasions of FIG. 6 can be said to be fully overlapped. Note that, in that example, MG occasion 606 (MG1) and MG occasion 608 (MG2) are not separated from each other by a time of at least the temporal proximity threshold, so there is contention between MG1 and MG2 within MGRP 624, and, with MG occasion 606 being within less than the temporal proximity threshold of gapless measurement occasion 612 and MG occasion 608 being within the temporal proximity threshold of gapless measurement occasion 616, FIG. 6 illustrates a fully overlapped example. In such case, a scaling factor Kp for measurement resource sharing is defined as equal to 1, and the gapless measurement occasions equally share the measurement resource with other MG occasions.

Measurement resource sharing can be implemented as described below. It can be observed that the gapless measurement period is less than the MGRP. Within each MGRP, for each gapless measurement occasion, the UE can find the MG occasion situated closest in time to that gapless measurement occasion. The UE can apply a temporal proximity rule (e.g., comparison to the temporal proximity threshold) to determine if the gapless measurement occasion is overlapped with the MG occasion or not. If all of the gapless measurement occasions within the MGRP are determined to be overlapping (e.g., conflicting, including when the temporal proximity rule is applied) with the closest MG occasion, the relationship of the gapless measurement occasions to the MG occasions is deemed to be fully overlapped. The UE can arrange for a gapless measurement (e.g., an intra-frequency measurement object (MO)) associated with the gapless measurement occasion (rather than with a MG) to equally share the measurement resource with other measurements (e.g., inter-frequency and intra-frequency MOs), which may be associated with a MG occasion. An instance of contention between a gapless measurement occasion and a MG occasion may be resolved by granting use of the gapless measurement occasion for gapless measurement and inhibiting use of the temporally proximate MG occasion. A different instance of contention between a gapless measurement occasion and a MG occasion may be resolved by granting use of the MG occasion for gap based measurement and inhibiting use of the temporally proximate gapless measurement occasion. By granting and inhibiting use of gapless measurement occasions and MG occasions for measurements in appropriate proportions (e.g., a round-robin sequence), a fair allocation of measurement resources for different types of measurements can be provided. As one example, a fair sequence can include inhibiting MG1 and MG2 occasions in one MGRP (e.g., MG occasion 606 and MG occasion 608 in MGRP 624) to allow use of corresponding temporally proximate gapless measurement occasions (e.g., gapless measurement occasions 612 and 616) to be used for gapless measurements and inhibiting temporally proximate gapless measurement occasions (e.g., gapless measurement occasion 620) in a subsequent MGRP to allow use of MG1 and MG2 occasions (e.g., MG occasion 610 and a following MG2 occasion) in the subsequent MGRP for gap based measurement. The sequence of gapless and gap based measurements can be continued in subsequent MGRPs. As another example, a fair sequence can include inhibiting a gapless measurement occasion temporally proximate to either a MG1 or MG2 occasion in one MGRP, using the corresponding MG1 or MG2 occasion for gap based measurement, inhibiting the opposite one of the MG1 and MG2 occasions in that MGRP and using the gapless measurement occasion temporally proximate to it for gapless measurement, then, in another MGRP, doing the same but with respect to the opposites of the MG1 and MG2 occasions to allow gap based measurements for both MG1 and MG2 and gapless measurements across multiple MGRPs.

For the example of FIG. 6, the intra-frequency MO (without MG) associated with this SMTC will occupy 1/((m1+m2)+1), and the total measurement period based on this SMTC would be extended by ((m1+m2)+1). As an example in the context of FIG. 6, if MG1 is used for measurements for two MOs and MG2 is used for measurements for three MOs, then Option 1 would yield a result of gapless measurements being made in 1/(5+1)=⅙ of the gapless measurement occasions, and the total measurement period would be extended to 5+1=6 times the amount of time that would have been used if gapless measurements could have been made in all gapless measurement occasions.

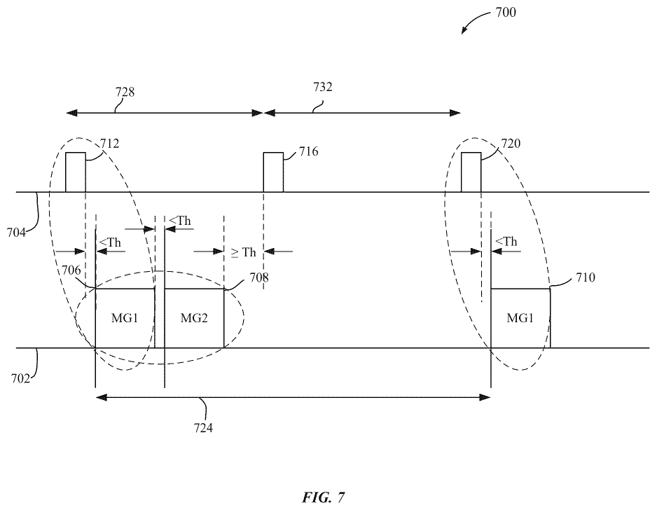

FIG. 7 is a timing diagram illustrating measurement resource sharing for a partially overlapped example with a plurality of MGs per MGRP in accordance with some aspects of the present disclosure. Measurement sharing scheme 700 of a UE, such as UE 102 of FIG. 1, is shown along time axis 702 for MGs occasions and along time axis 704, temporally aligned with time axis 702, for gapless measurement occasions. MGs 706, 708, and 710 are depicted along time axis 702. MG 706 and MG 708 are situated in MGRP 724, with MG 706 being denoted as MG1 and MG 708 being denoted as MG2. MG1 and MG2 repeat in each successive MGRP, as can be seen by MG 710 being the instance of MG1 situated in the MGRP following MGRP 724. In the depicted example, MGRP 724 is shown to have a duration of 40 milliseconds, and MG 706, MG 708, and MG 710 are shown to have MGLs of 6 milliseconds. Gapless measurement occasions 712, 716, and 720 are depicted along time axis 704. Gapless measurement occasion 712 is situated in gapless measurement repetition period 728. Gapless measurement occasion 716 is situated in gapless measurement repetition period 732. In the depicted example, gapless measurement repetition periods 728 and 732 are shown to have durations of 20 milliseconds, and gapless measurement durations are shown to have durations of 2 milliseconds. With the examples of MGRPs of 40 milliseconds and gapless measurement repetition periods of 20 milliseconds, gapless measurement repetition periods occur twice as frequently as MGRPs, but, since there are two MGs per MGRP, over a given time, there are equal numbers of gapless measurement occasions and MG occasions. Such ratios can vary in different implementations.

The temporal position of a gapless measurement occasion may or may not be temporally aligned with a MG. If a gapless measurement occasion is situated outside a MG, it may or may not be within a temporal proximity threshold of the MG, such as the leading or trailing edge of a MG.

A temporal proximity threshold may have a specified value, for example, 4 milliseconds.

In FIG. 7, gapless measurement occasion 712 is shown to be within the temporal proximity threshold of MG occasion 706 (MG1), gapless measurement occasion 720 is shown to be within the temporal proximity threshold of MG occasion 710 (MG1 of the next MGRP), and MG occasion 706 (MG1) is shown to be within the temporal proximity threshold of MG occasion 708 (MG2), but gapless measurement occasion 716 is shown to be at least the temporal proximity threshold away from MG occasion 708 (MG2). Thus, contention exists between gapless measurement occasion 712 and MG occasion 706, between gapless measurement occasion 720 and MG occasion 710, and between MG occasion 706 and MG occasion 708, but not between gapless measurement occasion 716 and its temporally closest MG occasion, which is MG occasion 708. Thus, with gapless measurement occasion 716 being non-overlapped, FIG. 7 illustrates a partially overlapped example. In such cases, a scaling factor Kp for the measurement resource sharing is defined as X/Y, where Y is the total number of SMTC occasions within the MGRP, including those overlapped and not-overlapped with measurement gap occasions within the MGRP based on proximity rule, and X is the number of SMTC occasions that are not overlapped with any MG occasion within the MGRP (which not meet the proximity rule). In the example of FIG. 7, the total number Y of SMTC occasions within the MGRP 724 equals to 2, and the number X of SMTC occasions that are not overlapped with any MG occasion within the MGRP 724 equals to 1, and thus the scaling factor Kp for the example of FIG. 7 is defined as X/Y=½=0.5.

Measurement resource sharing can be implemented as described below. It can be observed that the gapless measurement period is less than the MGRP. Within each MGRP, for each gapless measurement occasion, the UE can find the MG occasion situated closest in time to that gapless measurement occasion. The UE can apply a temporal proximity rule (e.g., comparison to the temporal proximity threshold) to determine if the gapless measurement occasion is overlapped with the MG occasion or not. Since some but not all of the gapless measurement occasions within the MGRP are determined to be overlapping (e.g., conflicting, including when the temporal proximity rule is applied) with the closest MG occasion, the relationship of the gapless measurement occasions to the MG occasions is deemed to be partially overlapped. The UE can arrange for a gapless measurement (e.g., an intra-frequency measurement object (MO)) associated with a gapless measurement occasion (rather than with a MG) to be performed in the gapless measurement occasion under the condition that the gapless measurement occasion is non-overlapped with any MG occasion. The UE can inhibit gapless measurement in the gapless measurement occasions which are overlapped with any MG occasion (including any temporal distance of less than the temporal proximity threshold preceding or following any MG occasion). The UE can enable gap based measurement to be performed in those MG occasions for which temporally proximate gapless measurement occasions are inhibited. Accordingly, the UE can allow gapless measurements (e.g., an intra-frequency MO (without a MG)) to be performed and also allow other measurements (e.g., inter-frequency and intra-frequency MOs) associated with a MG occasion to be performed. An instance of contention between a gapless measurement occasion and a MG occasion may be resolved by granting use of the MG occasion for gap based measurement and inhibiting use of the temporally proximate gapless measurement occasion, as other gapless measurement occasions without contention are available for gapless measurement in the partially overlapped case. By granting and inhibiting use of gapless measurement occasions and MG occasions for measurements in appropriate proportions (e.g., a round-robin sequence), a fair allocation of measurement resources for different types of measurements can be provided.

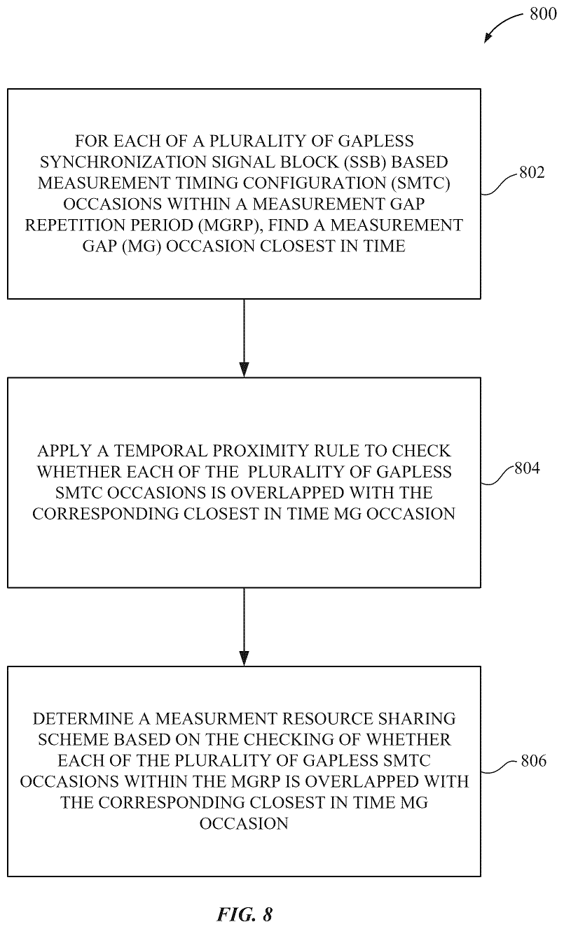

FIG. 8 is a flow diagram for a UE configured to perform measurement resource sharing in accordance with some aspects of the present disclosure. Method 800 comprises acts 802, 804, and 806. At act 802, for each of a plurality of gapless synchronization signal block (SSB) based measurement timing configuration (SMTC) occasions within a measurement gap repetition period (MGRP), a UE finds the measurement gap (MG) occasion closest in time to the gapless SMTC occasion. At act 804, the UE applies a temporal proximity rule to check whether each of the plurality of gapless SMTC occasions is overlapped with the corresponding closest in time MG occasion. At act 806, the UE determines a measurement resource sharing scheme based on the checking of whether each of the plurality of gapless SMTC occasions within the MGRP is overlapped with the corresponding closest in time MG occasion.

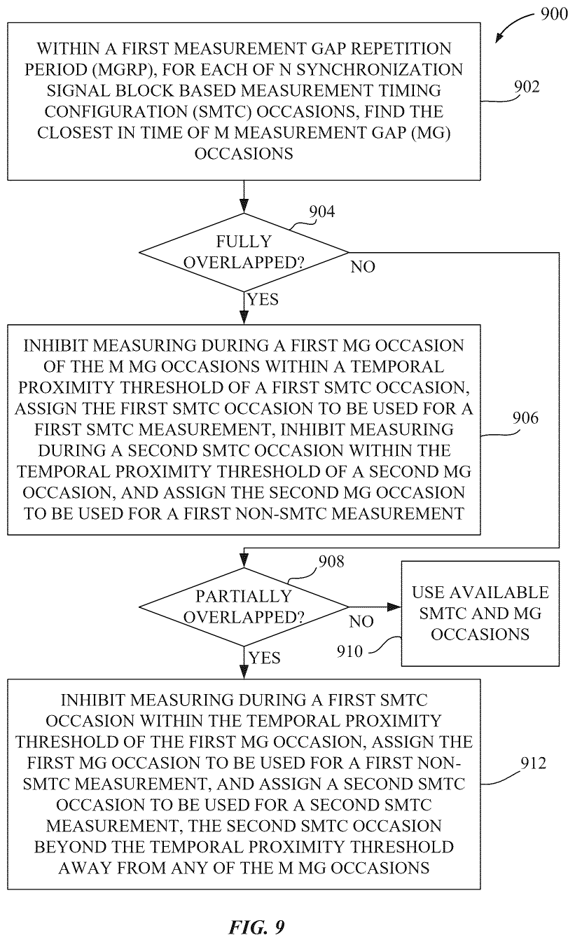

FIG. 9 is a flow diagram for a UE configured to perform measurement resource sharing in accordance with some aspects of the present disclosure. Method 900 comprises acts 902, 904, 906, 908, 910, and 912. At act 902, within a first measurement gap repetition period (MGRP), for each of N SMTC occasions, a UE finds the closest in time of M MG occasions. Act 904 is a decision block, at which the UE determines whether or not a relationship of the N SMTC occasions is fully overlapped with the M MG occasions. If so, at act 906, the UE inhibits measuring during a first MG occasion of the M MG occasions within a temporal proximity threshold of a first SMTC occasion, assigns the first SMTC occasion to be used for a first SMTC measurement, inhibits measuring during a second SMTC occasion within the temporal proximity threshold of a second MG occasion, and assigns the second MG occasion to be used for a first non-SMTC measurement.

If, at act 904, the UE determined that the relationship of the N SMTC occasions to the M MG occasions is not fully overlapped, the UE performs act 908, which is a decision block, where the UE determines whether the relationship of the N SMTC occasions to the M MG occasions is partially overlapped. If so, at act 912, the UE inhibits measuring during a first SMTC occasion within the temporal proximity threshold of the first MG occasion, assigns the first MG occasion to be used for a first non-SMTC measurement, and assigns a second SMTC occasion to be used for a second SMTC measurement. The second SMTC occasion is beyond the temporal proximity threshold away from any of the M MG occasions. If, at act 908, the UE determined that the relationship of the N SMTC occasions to the M MG occasions is not partially overlapped, the UE performs act 910, using available SMTC and MG occasions without restriction for a non-overlapped situation.

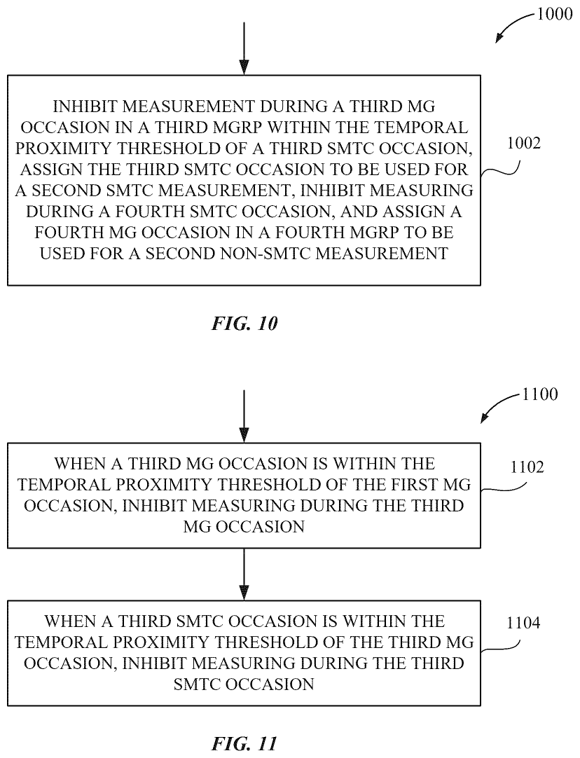

FIG. 10 is a flow diagram as a continuation of the flow diagram of FIG. 9 for a UE configured to perform measurement resource sharing in accordance with some aspects of the present disclosure. Submethod 1000 comprises act 1002, which the UE can perform, for example, following act 906 of FIG. 9. At act 1002, the UE inhibits measurement during a third MG occasion in a third MGRP within the temporal proximity threshold of a third SMTC occasion, assigns the third SMTC occasion to be used for a second SMTC measurement, inhibits measuring during a fourth SMTC occasion, and assigns a fourth MG occasion in a fourth MGRP to be used for a second non-SMTC measurement.

FIG. 11 is a flow diagram as a continuation of the flow diagram of FIG. 9 for a UE configured to measurement resource sharing in accordance with some aspects of the present disclosure. Submethod 1100 comprises act 1102 and act 1104. As an example, the UE can perform act 1102 following act 906 of FIG. 9. At act 1102, when a third MG occasion is within the temporal proximity threshold of the first MG occasion, the UE inhibits measuring during the third MG occasion. At act 1104, when a third SMTC occasion is within the temporal proximity threshold of the third MG occasion, the UT inhibits measuring during the third SMTC occasion.

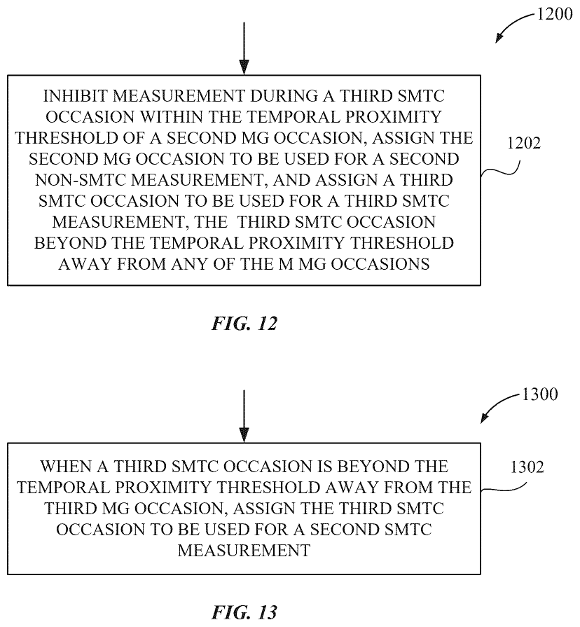

FIG. 12 is a flow diagram as a continuation of the flow diagram of FIG. 9 for a UE configured to perform measurement resource sharing in accordance with some aspects of the present disclosure. Submethod 1200 comprises act 1202, which the UE can, as an example, perform following act 912 of FIG. 9. At act 1202, the UE inhibits measurement during a third SMTC occasion within the temporal proximity threshold of a second MG occasion, assigns the second MG occasion to be used for a second non-SMTC measurement, and assigns a third SMTC occasion to be used for a third SMTC measurement, the third SMTC occasion beyond the temporal proximity threshold away from any of the M MG occasions.

FIG. 13 is a flow diagram as a continuation of the flow diagram of FIG. 9 for a UE configured to perform measurement resource sharing in accordance with some aspects of the present disclosure. Submethod 1300 comprises act 1302, which the UE can, as an example, perform following act 912 of FIG. 9. At act 1302, when a third SMTC occasion is beyond the temporal proximity threshold away from the third MG occasion, the UE assigns the third SMTC occasion to be used for a second SMTC measurement.

FIG. 14 is a timing diagram illustrating an example of fair distribution of measurement resources in accordance with some aspects of the present disclosure. A sequence 1400 of measurement resource occasions begins with gapless SMTC occasion 1402, followed at less than a temporal proximity threshold by MG occasion 1404, which is of a MG1 group of MG occasions and which begins a MGRP that ends at the beginning of MG occasion 1412. MG occasion 1404 is followed at less than a temporal proximity threshold by MG occasion 1406, which is of a MG2 group of MG occasions and is within the same MGRP as MC occasion 1404. MC occasion 1406 is followed at less than a temporal proximity threshold by gapless SMTC occasion 1408, which is also within the same MGRP as MG occasions 1404 and 1406. Gapless SMTC occasion 1408 is followed at a time greater than or equal to a temporal proximity threshold by gapless SMTC occasion 1410, which is also in the same MGRP as MG occasions 1404 and 1046 and gapless SMTC occasion 1408.

Of gapless SMTC occasion 1402, MG occasion 1404, MG occasion 1406, and gapless SMTC occasion 1408, which are within impermissible temporal proximity to one another, preventing the use of all of them for measurement, the UE selects one measurement resource occasion, in this case, gapless SMTC occasion 1402 to be used for gapless measurement and inhibits MG occasion 1404 and MG occasion 1406 from being used for measurement. However, the inhibiting of MG occasions 1404 and 1406 breaks the chain of impermissible temporal proximity between SMTC occasion 1402 and SMTC occasion 1408, allowing SMTC occasion 1408 to also be selected to be used for measurement.

Gapless SMTC occasion 1410 is followed at less than a temporal proximity threshold by MG occasion 1412, which is of the MG1 group and which begins a second MGRP. MG occasion 1412 is followed at less than a temporal proximity threshold by MG occasion 1414, which is of the MG2 group. MG occasion 1414 is followed at less than a temporal proximity threshold by gapless SMTC occasion 1416.

Of gapless SMTC occasion 1410, MG occasion 1412, MG occasion 1414, and SMTC occasion 1416, which are within impermissible temporal proximity to one another, preventing the use of all of them for measurement, the UE selects one measurement resource occasion, in this case, MG occasion 1412 to be used for gap based measurement and inhibits gapless SMTC occasion 1410, MG occasion 1414, and gapless SMTC occasion 1416 from being used for measurement.

Gapless SMTC occasion 1416 is followed at a time greater than or equal to a temporal proximity threshold by gapless SMTC occasion 1418. Gapless SMTC occasion 1418 is followed at less than a temporal proximity threshold by MG occasion 1420, which is of a MG1 group and which begins a third MGRP. MG occasion 1420 is followed at less than a temporal proximity threshold by MG occasion 1422, which is of the MG2 group. MG occasion 1422 is followed at less than a temporal proximity threshold by gapless SMTC occasion 1424.

Of gapless SMTC occasion 1418, MG occasion 1420, MG occasion 1422, and SMTC occasion 1424, which are within impermissible temporal proximity to one another, preventing the use of all of them for measurement, the UE selects one measurement resource occasion, in this case, MG occasion 1422 to be used for gap based measurement and inhibits gapless SMTC occasion 1418, MG occasion 1420, and gapless SMTC occasion 1422 from being used for measurement.

Gapless SMTC occasion 1424 is followed at a time greater than or equal to a temporal proximity threshold by gapless SMTC occasion 1426. Gapless SMTC occasion 1426 is followed at less than a temporal proximity threshold by MG occasion 1428, which is of a MG1 group and which begins a third MGRP. MG occasion 1428 is followed at less than a temporal proximity threshold by MG occasion 1430, which is of the MG2 group. MG occasion 1430 is followed at less than a temporal proximity threshold by gapless SMTC occasion 1432.

Of gapless SMTC occasion 1426, MG occasion 1428, MG occasion 1430, and SMTC occasion 1432, which are within impermissible temporal proximity to one another, preventing the use of all of them for measurement, the UE selects one measurement resource occasion, in this case, gapless SMTC occasion 1426 to be used for gapless measurement and inhibits MG occasion 1428, and MG occasion 1430 from being used for measurement. However, the inhibiting of MG occasions 1428 and 1430 breaks the chain of impermissible temporal proximity between SMTC occasion 1426 and SMTC occasion 1432, allowing SMTC occasion 1432 to also be selected to be used for measurement. At this point in the sequence, four gapless SMTC occasions (gapless SMTC occasion 1402, gapless SMTC occasion 1408, gapless SMTC occasion 1426, and gapless SMTC occasion 1432) have been selected to be used for gapless measurement, and two MG occasions (MG occasion 1412 and MG occasion 1422) have been selected to be used for gap based measurement, providing fairness and equality among measurement resource sharing. At this point, the selection sequence can be repeated, as will be described below.

Gapless SMTC occasion 1432 is followed at a time greater than or equal to a temporal proximity threshold by gapless SMTC occasion 1434. Gapless SMTC occasion 1434 is followed at less than a temporal proximity threshold by MG occasion 1436, which is of a MG1 group and which begins a third MGRP. MG occasion 1436 is followed at less than a temporal proximity threshold by MG occasion 1438, which is of the MG2 group. MG occasion 1438 is followed at less than a temporal proximity threshold by gapless SMTC occasion 1440. Of gapless SMTC occasion 1434, MG occasion 1436, MG occasion 1438, and SMTC occasion 1440, which are within impermissible temporal proximity to one another, preventing the use of all of them for measurement, the UE selects one measurement resource occasion, in this case, MG occasion 1436 to be used for gap based measurement and inhibits MG occasion 1436, MG occasion 1438, and gapless SMTC occasion 1440 from being used for measurement. As shown, a round-robin allocation scheme can be used, where, following the selection of SMTC occasion 1432 for use, MG occasion 1436 can be selected to be used for gap based measurement, providing a repeating pattern of SMTC-MG1-MG2-SMTC-MG1-MG2 . . . for measurement resource sharing. If either or both of MG1 or MG2 support more than one MO, multiple MOs per MG can take their turns in the round-robin allocation. For example, a sequence of SMTC-MG1MO1-MG2MO1-MG1MO2-MG2MO2-SMTC-MG1MO1-MG2MO1-MG1MO2-MG2MO2 . . . can be implemented for an example of MG1 having two MOs and MG2 having two MOs.

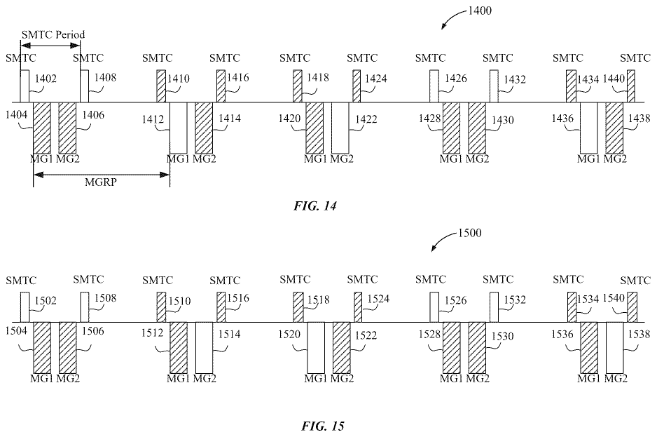

FIG. 15 is a timing diagram illustrating an example of fair distribution of measurement resources in accordance with some aspects of the present disclosure. As illustrated, different implementations may select among different of multiple MG occasions per MGRP in various orders. While FIG. 14 showed a MG1-MG2 selection order, FIG. 15 shows a MG2-MG1 selection order. Selection order of MOs for a MG may also be varied. A sequence 1500 of measurement resource occasions begins with gapless SMTC occasion 1502, followed at less than a temporal proximity threshold by MG occasion 1504, which is of a MG1 group of MG occasions and which begins a MGRP that ends at the beginning of MG occasion 1512. MG occasion 1504 is followed at less than a temporal proximity threshold by MG occasion 1506, which is of a MG2 group of MG occasions and is within the same MGRP as MC occasion 1504. MC occasion 1506 is followed at less than a temporal proximity threshold by gapless SMTC occasion 1508, which is also within the same MGRP as MG occasions 1504 and 1506. Gapless SMTC occasion 1508 is followed at a time greater than or equal to a temporal proximity threshold by gapless SMTC occasion 1510, which is also in the same MGRP as MG occasions 1504 and 1046 and gapless SMTC occasion 1508.

Of gapless SMTC occasion 1502, MG occasion 1504, MG occasion 1506, and gapless SMTC occasion 1508, which are within impermissible temporal proximity to one another, preventing the use of all of them for measurement, the UE selects one measurement resource occasion, in this case, gapless SMTC occasion 1502 to be used for gapless measurement and inhibits MG occasion 1504 and MG occasion 1506 from being used for measurement. However, the inhibiting of MG occasions 1504 and 1506 breaks the chain of impermissible temporal proximity between SMTC occasion 1502 and SMTC occasion 1508, allowing SMTC occasion 1508 to also be selected to be used for measurement.

Gapless SMTC occasion 1510 is followed at less than a temporal proximity threshold by MG occasion 1512, which is of the MG1 group and which begins a second MGRP. MG occasion 1512 is followed at less than a temporal proximity threshold by MG occasion 1514, which is of the MG2 group. MG occasion 1514 is followed at less than a temporal proximity threshold by gapless SMTC occasion 1516.

Of gapless SMTC occasion 1510, MG occasion 1512, MG occasion 1514, and SMTC occasion 1516, which are within impermissible temporal proximity to one another, preventing the use of all of them for measurement, the UE selects one measurement resource occasion, in this case, MG occasion 1514 to be used for gap based measurement and inhibits gapless SMTC occasion 1510, MG occasion 1512, and gapless SMTC occasion 1516 from being used for measurement.

Gapless SMTC occasion 1516 is followed at a time greater than or equal to a temporal proximity threshold by gapless SMTC occasion 1518. Gapless SMTC occasion 1518 is followed at less than a temporal proximity threshold by MG occasion 1520, which is of a MG1 group and which begins a third MGRP. MG occasion 1520 is followed at less than a temporal proximity threshold by MG occasion 1522, which is of the MG2 group. MG occasion 1522 is followed at less than a temporal proximity threshold by gapless SMTC occasion 1524.

Of gapless SMTC occasion 1518, MG occasion 1520, MG occasion 1522, and SMTC occasion 1524, which are within impermissible temporal proximity to one another, preventing the use of all of them for measurement, the UE selects one measurement resource occasion, in this case, MG occasion 1520 to be used for gap based measurement and inhibits gapless SMTC occasion 1518, MG occasion 1522, and gapless SMTC occasion 1522 from being used for measurement.

Gapless SMTC occasion 1524 is followed at a time greater than or equal to a temporal proximity threshold by gapless SMTC occasion 1526. Gapless SMTC occasion 1526 is followed at less than a temporal proximity threshold by MG occasion 1528, which is of a MG1 group and which begins a third MGRP. MG occasion 1528 is followed at less than a temporal proximity threshold by MG occasion 1530, which is of the MG2 group. MG occasion 1530 is followed at less than a temporal proximity threshold by gapless SMTC occasion 1532.

Of gapless SMTC occasion 1526, MG occasion 1528, MG occasion 1530, and SMTC occasion 1532, which are within impermissible temporal proximity to one another, preventing the use of all of them for measurement, the UE selects one measurement resource occasion, in this case, gapless SMTC occasion 1526 to be used for gapless measurement and inhibits MG occasion 1528, and MG occasion 1530 from being used for measurement. However, the inhibiting of MG occasions 1528 and 1530 breaks the chain of impermissible temporal proximity between SMTC occasion 1526 and SMTC occasion 1532, allowing SMTC occasion 1532 to also be selected to be used for measurement. At this point in the sequence, four gapless SMTC occasions (gapless SMTC occasion 1502, gapless SMTC occasion 1508, gapless SMTC occasion 1526, and gapless SMTC occasion 1532) have been selected to be used for gapless measurement, and two MG occasions (MG occasion 1512 and MG occasion 1522) have been selected to be used for gap based measurement, providing fairness and equality among measurement resource sharing. At this point, the selection sequence can be repeated, as will be described below.

Gapless SMTC occasion 1532 is followed at a time greater than or equal to a temporal proximity threshold by gapless SMTC occasion 1534. Gapless SMTC occasion 1534 is followed at less than a temporal proximity threshold by MG occasion 1536, which is of a MG1 group and which begins a third MGRP. MG occasion 1536 is followed at less than a temporal proximity threshold by MG occasion 1538, which is of the MG2 group. MG occasion 1538 is followed at less than a temporal proximity threshold by gapless SMTC occasion 1540.

Of gapless SMTC occasion 1534, MG occasion 1536, MG occasion 1538, and SMTC occasion 1540, which are within impermissible temporal proximity to one another, preventing the use of all of them for measurement, the UE selects one measurement resource occasion, in this case, MG occasion 1536 to be used for gap based measurement and inhibits MG occasion 1536, MG occasion 1538, and gapless SMTC occasion 1540 from being used for measurement. As shown, a round-robin allocation scheme can be used, where, following the selection of SMTC occasion 1532 for use, MG occasion 1536 can be selected to be used for gap based measurement, providing a repeating pattern of SMTC-MG2-MG1-SMTC-MG2-MG1 . . . for measurement resource sharing. If either or both of MG1 or MG2 support more than one MO, multiple MOs per MG can take their turns in the round-robin allocation. For example, a sequence of SMTC-MG2MO1-MG1MO1-MG2MO2-MG1MO2-SMTC-MG2MO1-MG1MO1-MG2MO2-MGIMO2 . . . can be implemented for an example of MG1 having two MOs and MG2 having two MOs.

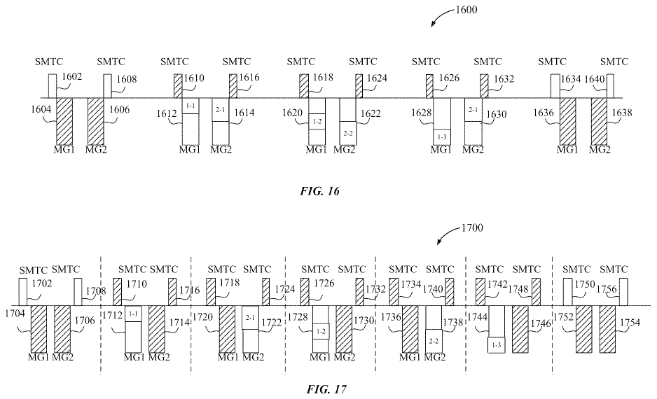

FIG. 16 is a timing diagram illustrating an example measurement resource sharing sequence in relation to Option 1 discussed with respect to FIG. 5. As discussed above, the intra-frequency MO (without MG) associated with this SMTC will occupy 1/(max(m1,m2)+1), and the total measurement period based on this SMTC would be extended by (max(m1,m2)+1). As an example in the context of FIG. 5, if MG1 is used for measurements for three MOs and MG2 is used for measurements for two MOs, then Option 1 would yield a result of gapless measurements being made in 1/(3+1)=¼ of the gapless measurement occasions, and the total measurement period would be extended to 3+1=4 times the amount of time that would have been used if gapless measurements could have been made in all gapless measurement occasions. Since, in FIG. 5, MG occasion 506 and MG occasion 508 do not conflict with each other, both can be used for measuring according to their respective MOs, so at least one measurement for each MO of both MG1 and MG2 can be made between allowances of gapless measurements when using Option 1. That measurement resource sharing scheme can be seen over time in FIG. 16, as discussed below.

Among conflicting gapless measurement occasion 1602 and MG occasion 1604 for MG1, gapless measurement occasion 1602 is selected for use, and MG occasion 1604 is inhibited. Among MG occasion 1606 for MG2 and gapless measurement occasion 1608, gapless measurement occasion 1608 is selected for use, and MG occasion 1606 is inhibited. Among conflicting gapless measurement occasion 1610 and MG occasion 1612 for MG1, MG occasion 1612 for MG1 is selected to be used for the first of the three MOs for MG1, and gapless measurement occasion 1610 is inhibited. Among conflicting MG occasion 1614 for MG2 and gapless measurement occasion 1616, MG occasion 1614 is selected to be used for the first of two MOs for MG2. Among conflicting gapless measurement occasion 1618 and MG occasion 1620 for MG1, MG occasion 1620 for MG1 is selected to be used for the second of the three MOs for MG1, and gapless measurement occasion 1618 is inhibited. Among conflicting MG occasion 1622 for MG2 and gapless measurement occasion 1624, MG occasion 1622 is selected to be used for the second of two MOs for MG2. Among conflicting gapless measurement occasion 1626 and MG occasion 1628 for MG1, MG occasion 1628 for MG1 is selected to be used for the third of the three MOs for MG1, and gapless measurement occasion 1626 is inhibited. Among conflicting MG occasion 1630 for MG2 and gapless measurement occasion 1632, MG occasion 1630 is selected to be used for the next instance of the first of two MOs for MG2. Among conflicting gapless measurement occasion 1634 and MG occasion 1636 for MG1, gapless measurement occasion 1634 is selected for use, and MG occasion 1636 is inhibited. Among MG occasion 1638 for MG2 and gapless measurement occasion 1640, gapless measurement occasion 1640 is selected to be used for gapless measurement, and MG occasion 1638 is inhibited.

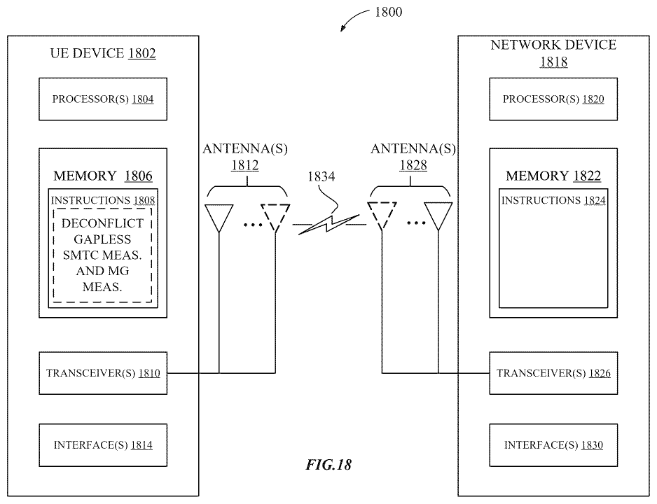

FIG. 17 is a timing diagram illustrating an example measurement resource sharing sequence in relation to FIG. 6. As discussed above, the intra-frequency MO (without MG) associated with this SMTC will occupy 1/(m1+m2)+1), and the total measurement period based on this SMTC would be extended by (m1+m2)+1). As an example in the context of FIG. 6, if MG1 is used for measurements for three MOs and MG2 is used for measurements for two MOs, then the result would be gapless measurements being made in 1/(5+1)=⅙ of the gapless measurement occasions, and the total measurement period would be extended to 5+1=6 times the amount of time that would have been used if gapless measurements could have been made in all gapless measurement occasions. Since, in FIG. 6, MG occasion 606 and MG occasion 608 do conflict with each other, both cannot be used in the same MGRP for measuring according to their respective MOs. If one or the other of them is selected to be used, then either a MO for MG1 or a MO for MG2 can be measured in that MGRP. That measurement resource sharing scheme can be seen over time in FIG. 17, as discussed below.

Among conflicting gapless measurement occasion 1702, MG occasion 1704 for MG1, MG occasion 1706 for MG2, and gapless measurement occasion 1708, gapless measurement occasion 1702 is selected for use, and MG occasions 1704 and 1706 are inhibited. Since inhibiting MG occasions 1704 and 1706 breaks the chain of temporal proximities that had existed between gapless measurement occasions 1702 and 1708, adequate time of at least the temporal proximity threshold exists between gapless measurement occasions 1704 and 1706, and both of them can be used for gapless measurement. Thus, along with gapless measurement occasion 1602, gapless measurement occasion 1608 is also selected for gapless measurement.

Among conflicting gapless measurement occasion 1710, MG occasion 1712 for MG1, MG occasion 1714 for MG1, and gapless measurement occasion 1716, MG occasion 1712 for MG1 is selected to be used for the first of the three MOs for MG1, and gapless measurement occasion 1710, MG occasion 1714, and gapless measurement occasion 1716 are inhibited.

Among conflicting gapless measurement occasion 1718, MG occasion 1720 for MG1, MG occasion 1722 for MG2, and gapless measurement occasion 1724, MG occasion 1722 is selected to be used for the first of two MOs for MG2. Among conflicting gapless measurement occasion 1726, MG occasion 1728 for MG1, MG occasion 1730 for MG2, and gapless measurement occasion 1732, MG occasion 1728 for MG1 is selected to be used for the second of the three MOs for MG1, and gapless measurement occasion 1726, MG occasion 1730, and gapless measurement occasion 1732 are inhibited. Among conflicting gapless measurement occasion 1734, MG occasion 1736 for MG1, MG occasion 1738 for MG2, and gapless measurement occasion 1740, MG occasion 1738 is selected to be used for the second of two MOs for MG2. Among conflicting gapless measurement occasion 1742, MG occasion 1744 for MG1, MG occasion 1746 for MG2, and gapless measurement occasion 1748, MG occasion 1744 for MG1 is selected to be used for the third of the three MOs for MG1, and gapless measurement occasion 1742, MG occasion 1746, and gapless measurement occasion 1748 are inhibited. Among conflicting gapless measurement occasion 1750, MG occasion 1752 for MG 1, MG occasion 1754 for MG2, and gapless measurement occasion 1756, gapless measurement occasion 1750 and gapless measurement occasion 1756 are selected for gapless measurement.

The breaking of the chain of temporal proximity conflicts by the inhibiting of MG occasions 1752 and 1754 allows both of gapless measurement occasions 1750 and 1756 to be used.

FIG. 18 is a block diagram illustrating a wireless communication system including a UE device and a network device in accordance with some aspects of the present disclosure. In system 1800, signaling 1834 is performed between a wireless device 1802 and a network device 1818 in accordance with at least one aspect disclosed herein. The system 1800 may be a portion of a wireless communications system as herein described. The wireless device 1802 may be, for example, a UE of a wireless communication system. The network device 1818 may be, for example, a base station (e.g., an evolved next generation base station (eNB) or a next generation base station (gNB)) of a wireless communication system.

The wireless device 1802 may include one or more processor(s) 1804. The processor(s) 1804 may execute instructions such that various operations of the wireless device 1802 are performed, as described herein. The processor(s) 1804 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1802 may include a memory 1806. The memory 1806 may be a non-transitory computer-readable storage medium that stores instructions 1808 (which may include, for example, the instructions being executed by the processor(s) 1804). The instructions 1808 may also be referred to as program code or a computer program. The memory 1806 may also store data used by, and results computed by, the processor(s) 1804.

The wireless device 1802 may include one or more transceiver(s) 1810 that may include radio frequency (RF) transmitter and/or receiver circuitry that use the antenna(s) 1812 of the wireless device 1802 to facilitate signaling (e.g., the signaling 1834) to and/or from the wireless device 1802 with other devices (e.g., the network device 1818) according to corresponding RATs.

The wireless device 1802 may include one or more antenna(s) 1812 (e.g., one, two, four, or more). For aspects with multiple antenna(s) 1812, the wireless device 1802 may leverage the spatial diversity of such multiple antenna(s) 1812 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1802 may be accomplished according to precoding (or digital beamforming) that is applied at the wireless device 1802 that multiplexes the data streams across the antenna(s) 1812 according to known or assumed channel characteristics such that each data stream is received with an appropriate signal strength relative to other streams and at a desired location in the spatial domain (e.g., the location of a receiver associated with that data stream). Certain aspects may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain aspects having multiple antennas, the wireless device 1802 may implement analog beamforming techniques, whereby phases of the signals sent by the antenna(s) 1812 are relatively adjusted such that the (joint) transmission of the antenna(s) 1812 can be directed (this is sometimes referred to as beam steering).

The wireless device 1802 may include one or more interface(s) 1814. The interface(s) 1814 may be used to provide input to or output from the wireless device 1802. For example, a wireless device 1802 that is a UE may include interface(s) 1814 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 1810/antenna(s) 1812 already described) that allow for communication between the UE and other devices and may operate according to known protocols (e.g., Wi-Fi®, Bluetooth®, and the like).

The network device 1818 may include one or more processor(s) 1820. The processor(s) 1820 may execute instructions such that various operations of the network device 1818 are performed, as described herein. The processor(s) 1804 may include one or more baseband processors implemented using, for example, a CPU, a DSP, an ASIC, a controller, an FPGA device, another hardware device, a firmware device, or any combination thereof configured to perform the operations described herein.

The network device 1818 may include a memory 1822. The memory 1822 may be a non-transitory computer-readable storage medium that stores instructions 1824 (which may include, for example, the instructions being executed by the processor(s) 1820). The instructions 1824 may also be referred to as program code or a computer program. The memory 1822 may also store data used by, and results computed by, the processor(s) 1820.

The network device 1818 may include one or more transceiver(s) 1826 that may include RF transmitter and/or receiver circuitry that use the antenna(s) 1828 of the network device 1818 to facilitate signaling (e.g., the signaling 1834) to and/or from the network device 1818 with other devices (e.g., the wireless device 1802) according to corresponding RATs.

The network device 1818 may include one or more antenna(s) 1828 (e.g., one, two, four, or more). In aspects having multiple antenna(s) 1828, the network device 1818 may perform MIMO, digital beamforming, analog beamforming, beam steering, etc., as has been described.

The network device 1818 may include one or more interface(s) 1830. The interface(s) 1830 may be used to provide input to or output from the network device 1818. For example, a network device 1818 that is a base station may include interface(s) 1830 made up of transmitters, receivers, and other circuitry (e.g., other than the transceiver(s) 1826/antenna(s) 1828 already described) that enables the base station to communicate with other equipment in a core network, and/or that enables the base station to communicate with external networks, computers, databases, and the like for purposes of operations, administration, and maintenance of the base station or other equipment operably connected thereto.

In accordance with at least one aspect, instructions 1808 of memory 1806 may comprise instructions to resolve temporal conflicts (i.e., deconflict) between gapless measurement occasions (e.g., SMTC measurement occasions) and gap based measurement occasions (e.g., MG occasions). Examples detailing such operation of UE device 1802, such as UE 102, to effect a measurement sharing scheme that resolves any such temporal conflicts, including temporal conflicts arising by operation of a temporal proximity rule, and at least one method for effecting a measurement sharing scheme that resolves any such temporal conflicts are disclosed herein.

In some aspects, for a single MG scenario, when SMTC period<MGRP, the following acts can be performed, for example, by a UE:

Within a MGRP, for each SMTC occasion, the UE can find the closest MG occasion to the SMTC occasion. The UE can use proximity rule to determine if SMTC is overlapped with MG or not. If all SMTCs inside the MGRP are determined to be colliding with their respective closest MG, such case will still be treated as a fully overlapped case with the measurement resource sharing scaling factor Kp=1. The intra-frequency MO (without MG) associated with this SMTC can equally share the measurement resource with other inter-frequency and intra-frequency MOs (with MGs). If not all SMTCs inside the MGRP are determined to be colliding with their respective closest MG, such case will be treated as a partially overlapped case with the measurement resource sharing scaling factor Kp=X/Y, where Y is the total number of SMTC occasions within the MGRP, including those overlapped and not-overlapped with measurement gap occasions within the MGRP based on proximity rule, and X is the number of SMTC occasions that are not overlapped with any MG occasion within the MGRP (which not meet the proximity rule).

In some aspects, for a multiple MG per MGRP scenario (e.g., a dual MG per MGRP scenario, such as where two distinct MG patterns are configured, for example, for a NTN situation), the following acts can be performed, for example, by a UE:

For a window of max(SMTC period, max MGRP), where max MGRP is the maximum MGRP across all configured per-UE measurement gap and/or per-FR measurement gap within the same FR as the SSB frequency layer, and starting from the beginning of any SMTC occasion, the UE will find, for each SMTC occasion, the closest MG occasion to the SMTC occasion. The UE will use a proximity rule to determine if the SMTC is overlapped with the closest MG or not. If all SMTCs inside this window are determined to be colliding with their respective closest MG, but the MGs are not colliding with each other, such case will be treated as a fully overlapped case with the measurement resource sharing scaling factor Kp=1. The intra-frequency MO (without MG) associated with this SMTC can share the measurement resource with other inter-frequency and intra-frequency MOs (with MGs) based on following options, with MG1 associated with m1 MOs and MG2 associated with m2 MOs:
Option 1: the intra-frequency MO (without MG) associated with this SMTC will occupy 1/(max(m1,m2)+1), and the total measurement period based on this SMTC would be extended by (max(m1,m2)+1)
Option 2: the intra-frequency MO (without MG) associated with this SMTC will occupy 1/(min(m1,m2)+1), and the total measurement period based on this SMTC would be extended by (min(m1,m2)+1)
Option 3: the intra-frequency MO (without MG) associated with this SMTC will occupy 1/((m1+m2)+1), and the total measurement period based on this SMTC would be extended by ((m1+m2)+1)
Option 4: if N SMTC are needed for measurement, the total measurement period based on this SMTC would be extended to (N/2)*(m1+1)+(N/2)*(m2+1), if N is even number, and the total measurement period based on this SMTC would be extended to ((N+1)/2)*(m1+1)+((N−1)/2)*(m2+1) or ((N−1)/2)*(m1+1)+((N+1)/2)*(m2+1), if N is odd number.

In some aspects, for a multiple MG per MGRP scenario (e.g., a dual MG per MGRP scenario, such as where two distinct MG patterns are configured, for example, for a NTN situation), the following acts can be performed, for example, by a UE:

For a window of max(SMTC period, max MGRP), where max MGRP is the maximum MGRP across all configured per-UE measurement gap and/or per-FR measurement gap within the same FR as the SSB frequency layer, and starting from the beginning of any SMTC occasion, the UE will find, for each SMTC occasion, the closest MG occasion to the SMTC occasion. The UE will use a proximity rule to determine if the SMTC is overlapped with the closest MG or not. If all SMTCs inside this window are determined as colliding with their respective closest MG, and MG are colliding with each other, such case will be treated as a fully overlapped case with the measurement resource sharing scaling factor Kp=1. The intra-frequency MO (without MG) associated with this SMTC can share the measurement resource with other inter-frequency and intra-frequency MOs (with MGs) based on following options, with MG1 associated with m1 MOs and MG2 associated with m2 MOs:

The intra-frequency MO (without MG) associated with this SMTC will occupy 1/((m1+m2)+1), and the total measurement period based on this SMTC would be extended by ((m1+m2)+1).

In some aspects, for a multiple MG per MGRP scenario (e.g., a dual MG per MGRP scenario, such as where two distinct MG patterns are configured, for example, for a NTN situation), the following acts can be performed, for example, by a UE:

For a window of max(SMTC period, max MGRP), where max MGRP is the maximum MGRP across all configured per-UE measurement gap and/or per-FR measurement gap within the same FR as the SSB frequency layer, and starting from the beginning of any SMTC occasion, the UE will find, for each SMTC occasion, the closest MG occasion to this SMTC occasion. The UE will use proximity rule to determine if the SMTC is overlapped with the closest MG or not. If not all SMTCs inside this window are determined as colliding with their respective closest MG, regardless of whether MGs are colliding with each other, such case will be treated as a partially overlapped case with the measurement resource sharing scaling factor Kp=X/Y, where Y is the total number of SMTC occasions within the MGRP, including those overlapped and not-overlapped with measurement gap occasions within the MGRP based on proximity rule, and X is the number of SMTC occasions that are not overlapped with any non-dropped MG occasion within this window.

While the methods are illustrated and described above as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or examples of the disclosure herein. Also, one or more of the acts depicted herein may be carried out in one or more separate acts and/or phases. In some examples, the methods illustrated above may be implemented in a computer readable medium using instructions stored in a memory. Many other examples and variations are possible within the scope of the claimed disclosure.

As it is employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor can also be implemented as a combination of computing processing units. The processor or baseband processor can be configured to execute instructions described herein.

Examples (aspects) can include subject matter such as a method, means for performing acts or blocks of the method, at least one machine-readable medium including instructions that, when performed by a machine (e.g., a processor with memory, an application-specific integrated circuit (ASIC), a field programmable gate array (FPGA), or the like) cause the machine to perform acts of the method or of an apparatus or system for concurrent communication using multiple communication technologies according to aspects and examples described herein.

Example 1 can include a User Equipment (UE), comprising one or more processors configured to cause the UE to, for each of a plurality of gapless synchronization signal block (SSB) based measurement timing configuration (SMTC) occasions within a measurement gap repetition period (MGRP), determine a measurement gap (MG) occasion that is closest in time; apply a temporal proximity rule to check whether each of the plurality of gapless SMTC occasions is overlapped with the corresponding closest in time MG occasion; determine a measurement resource sharing scheme based on the checking of whether each of the plurality of gapless SMTC occasions within the MGRP is overlapped with the corresponding closest in time MG occasion; and conduct one or more measurements based on the measurement resource sharing scheme.

Example 2 can include Example 1, and the measurement resource sharing scheme can further include, when each of the plurality of gapless SMTC occasions within the MGRP is overlapped with the corresponding closest in time MG occasion, the plurality of gapless SMTC occasions equally shares measurement resources with other measurement objects using MG occasions.

Example 3 can include Example 1, and the measurement resource sharing scheme can further include, when each of the plurality of gapless SMTC occasions within the MGRP is overlapped with the corresponding closest in time MG occasion, a first overlapped gapless SMTC occasion is enabled for use for a gapless measurement, a first overlapped MG occasion is inhibited, the first overlapped MG occasion situated within a temporal proximity threshold of the first overlapped gapless SMTC occasion, a second overlapped gapless SMTC occasion is inhibited, and a second overlapped MG occasion is enabled for use for gap based measurement, the second overlapped MG occasion situated within a temporal proximity threshold of the second overlapped SMTC occasion.

Example 4 can include Example 1, and the measurement resource sharing scheme can further include when fewer than all of a plurality of gapless SMTC occasions within the MGRP are overlapped with the corresponding closest in time MG occasion, a first non-overlapped gapless SMTC occasion is enabled for use for a gapless measurement, a first overlapped gapless SMTC occasion is inhibited, and a first overlapped MG occasion is enabled for use for gap based measurement, the first overlapped MG occasion situated within a temporal proximity threshold of the first overlapped SMTC occasion.

Example 5 can include Example 1, and the measurement resource sharing scheme can further include, when a first MG occasion is within a temporal proximity threshold of a second MG occasion, inhibiting use of the first MG occasion and enabling use of the second MG occasion for gap based measurement.

Example 6 can include Example 1, and the measurement resource sharing scheme can further include, when each of the plurality of gapless SMTC occasions is overlapped with the corresponding closest in time MG occasion, and a first MG occasion is overlapped with a second MG occasion, the plurality of gapless SMTC occasions equally shares measurement resources with other measurement objects (MOs) using the first and second MG occasions.

Example 7 can include Example 1 and Example 6, and the measurement resource sharing scheme can further include, when a first MG occasion is within a temporal proximity threshold of a second MG occasion and the second MG occasion is within the temporal proximity threshold of a first SMTC occasion, enabling measurement of a first measurement object (MO) associated with the first MG occasion, inhibiting measurement of a second MO associated with the second MG occasion, and inhibiting a gapless measurement within the temporal proximity threshold at least one of the first MO and the second MO.

Example 8 can include Example 1, and the measurement resource sharing scheme can further include, when at least one gapless SMTC occasion of the plurality of gapless SMTC occasions is not overlapped with the corresponding closest in time MG occasion, the plurality of gapless SMTC occasions are measured only during the at least one gapless SMTC occasion and not measured during other gapless SMTC occasions that overlap with any of the MG occasions.

Example 9 can include Example 1, and the measurement resource sharing scheme can further include, when each of the plurality of gapless SMTC occasions within the MGRP is overlapped with the corresponding closest in time MG occasion, allocating measurement resources in a round-robin manner among gapless measurements during a subset of the plurality of gapless SMTC occasions and other measurement objects during MG occasions.

Example 10 can include Example 1, and the measurement resource sharing scheme can further include, when fewer than all of a plurality of gapless SMTC occasions within the MGRP are overlapped with the corresponding closest in time MG occasion, allocating measurement resources to provide gapless measurements during the plurality of gapless SMTC occasions in proportion to other measurement objects using MG occasions according to a measurement resource sharing scaling factor having a value equal to a fraction having a numerator equal to a first number of SMTC windows within a measurement gap repetition period (MGRP) that do not conflict with any MG within the MGRP and a denominator equal to a total number of SMTC windows within the MGRP.

Example 11 can include Example 1, and the measurement resource sharing scheme can further include, when a first MG occasion is beyond a temporal proximity threshold away from a second MG occasion and the second MG occasion is within the temporal proximity threshold of a first SMTC occasion, enabling use of the first MG occasion for measurement according to a measurement object (MO), inhibiting use of the second MG occasion, and enabling use of the first SMTC occasion for a gapless measurement.

Example 12 can include Example 1 and Example 11 and further wherein enabling use of the first MG occasion comprises selecting the MO according to a round-robin selection among a plurality of MOs associated with any of one or more MGs.

Example 13 can include Example 1 and Example 11 and Example 12 and further wherein the round-robin selection comprises selecting among a plurality of MOs in sequence for respective measurements of the plurality of MOs to be performed; and, when two MGs are defined per MGRP, every once in one more than the maximum of a first number of MOs associated with the first MG and a second number of MOs associated with the second MG, selecting a SSB based measurement to be performed.

Example 14 can include Example 1 and Example 11 and Example 12 and further wherein the round-robin selection comprises selecting among a plurality of MOs in sequence for respective measurements of the plurality of MOs to be performed; and, when two MGs are defined per MGRP, every once in one more than the minimum of a first number of MOs associated with the first MG and a second number of MOs associated with the second MG, selecting a SSB based measurement to be performed.

Example 15 can include Example 1 and Example 11 and Example 12 and further wherein the round-robin selection comprises selecting among a plurality of MOs in sequence for respective measurements of the plurality of MOs to be performed; and, when two MGs are defined per MGRP, every once in one more than the sum of a first number of MOs associated with the first MG and a second number of MOs associated with the second MG, selecting a SSB based measurement to be performed.

Example 16 can include Example 1 and Example 11 and Example 12 and further wherein the round-robin selection comprises selecting among a plurality of MOs in sequence for respective measurements of the plurality of MOs to be performed; and, when two MGs are defined per MGRP, and N SSB based measurement are to be performed and N is an even number, every once in (N/2)*(m1+1)+(N/2)*(m2+1), where m1 represents a first number of MOs associated with the first MG and m2 represents a second number of MOs associated with the second MG, selecting a SSB based measurement to be performed.

Example 17 can include Example 1 and Example 11 and Example 12 and further wherein the round-robin selection comprises selecting among a plurality of MOs in sequence for respective measurements of the plurality of MOs to be performed; and, when two MGs are defined per MGRP, and N SSB based measurement are to be performed and N is an odd number, every once in ((N+1)/2)*(m1+1)+((N−1)/2)*(m2+1), where m1 represents a first number of MOs associated with the first MG and m2 represents a second number of MOs associated with the second MG, selecting a SSB based measurement to be performed.

Example 18 can include Example 1 and Example 11 and Example 12 and further wherein the round-robin selection comprises selecting among a plurality of MOs in sequence for respective measurements of the plurality of MOs to be performed; and, when two MGs are defined per MGRP, and N SSB based measurement are to be performed and N is an odd number, every once in ((N−1)/2)*(m1+1)+((N+1)/2)*(m2+1), where m1 represents a first number of MOs associated with the first MG and m2 represents a second number of MOs associated with the second MG, selecting a SSB based measurement to be performed.

Example 19 can include Example 1 and wherein the measurement resource sharing scheme comprises, when a first SMTC occasion is within a temporal proximity threshold of a first MG occasion, the first MG occasion is within a temporal proximity threshold of a second MG occasion, and the second MG occasion is within the temporal proximity threshold of a second SMTC occasion, selecting among a plurality of MOs in sequence for respective measurements of the plurality of MOs to be performed, and, when two MGs are defined per MGRP, every once in one more than the sum of a first number of MOs associated with a first MG and a second number of MOs associated with a second MG, selecting a SSB based measurement to be performed.

Example 20 can include Example 1 and Example 19 and wherein selecting among a plurality of MOs in sequence for respective measurements of the plurality of MOs to be performed comprises selecting a MO of the plurality of MOs according to a round-robin selection.

Example 21 can include a User Equipment (UE) comprising a memory and a processor coupled to the memory and configured to execute instructions stored in the memory to cause the UE to: within a first measurement gap repetition period (MGRP), for each of n synchronization signal block (SSB) based measurement timing configuration (SMTC) occasions, determine the closest in time of m measurement gap (MG) occasions; apply a temporal proximity rule to determine if the n SMTC occasions are fully overlapped, partially overlapped, or not overlapped in time with the m MG occasions; when the n SMTC occasions are fully overlapped with the m MG occasions, inhibit measuring during a first MG occasion of the m MG occasions within a temporal proximity threshold of a first SMTC occasion of the n SMTC occasions, assign the first SMTC occasion to be used for a first SMTC measurement, inhibit measuring during a second SMTC occasion of the n SMTC occasions within the temporal proximity threshold of a second MG occasion, and assign the second MG occasion to be used for a first non-SMTC measurement; and, when the n SMTC occasions are partially overlapped with the m MG occasions, inhibit measuring during a first SMTC occasion of the n SMTC occasions within the temporal proximity threshold of a first MG occasion of the m MG occasions, assign the first MG occasion to be used for a first non-SMTC measurement, and assign a second SMTC occasion to be used for a second SMTC measurement, the second SMTC occasion beyond the temporal proximity threshold away from any of the m MG occasions.

Example 22 can comprise Example 11, wherein the processor is further configured, by executing the instructions, cause the UE to: when the n SMTC occasions are fully overlapped with the m MG occasions, inhibit measuring during a third MG occasion in a third MGRP within the temporal proximity threshold of a third SMTC occasion of the n SMTC occasions, assign the third SMTC occasion to be used for a second SMTC measurement, inhibit measuring during a fourth SMTC occasion of the n SMTC occasions, and assign a fourth MG occasion in a fourth MGRP to be used for a second non-SMTC measurement.

Example 23 can include Example 11, wherein the first MG occasion is within the first MGRP, and the second MG occasion is within a second MGRP different from the first MGRP.

Example 24 can include Example 11, wherein the processor is further configured, by executing the instructions, cause the UE to: when the n SMTC occasions are fully overlapped with the m MG occasions, when a third MG occasion is within the temporal proximity threshold of the first MG occasion, inhibit measuring during the third MG occasion.

Example 25 can include Example 11, wherein the processor is further configured, by executing the instructions, cause the UE to: when the n SMTC occasions are fully overlapped with the m MG occasions, when a third SMTC occasion is within the temporal proximity threshold of the third MG occasion, inhibit measuring during the third SMTC occasion.

Example 26 can include Example 11, wherein the processor is further configured, by executing the instructions, when the n SMTC occasions are partially overlapped with the m MG occasions, to cause the UE to inhibit measuring during a third SMTC occasion of the n SMTC occasions within the temporal proximity threshold of a second MG occasion, assign the second MG occasion to be used for a second non-SMTC measurement, and assign a third SMTC occasion to be used for a third SMTC measurement, the third SMTC occasion beyond the temporal proximity threshold away from any of the m MG occasions.

Example 27 can include Example 11 and Example 16 and further wherein the first MG occasion is within the first MGRP, the second MG occasion is within a second MGRP different from the first MGRP.

Example 28 can include Example 11 and wherein the processor is further configured, by executing the instructions, when the n SMTC occasions are partially overlapped with the m MG occasions, when a third SMTC occasion is beyond the temporal proximity threshold away from a third MG occasion, to cause the UE to assign the third SMTC occasion to be used for a second SMTC measurement.

Example 29 can include a method comprising, for a period of time at least as long as a measurement gap repetition period (MGRP), determining, at a user equipment (UE), if all synchronization signal block (SSB) measurement timing configuration (SMTC) occasions are within less than an temporal proximity threshold of any of one or more measurement gap (MG) occasions; when all of the SMTC occasions are within less than the temporal proximity threshold of any of the MG occasions, allocating, at the UE, measurement resources to provide equal sharing among gapless measurements during a subset of the SMTC occasions and other measurement objects during a subset of the one or more MG occasions; for the period of time, determining, at the UE, if any but not all of the SMTC occasions are within less than the temporal proximity threshold of any of the one or more MG occasions; and, when any but not all of the SMTC occasions are within less than the temporal proximity threshold of any of the MG occasions, allocating, at the UE, non-overlapped SMTC occasions of the SMTC occasions to be used for gapless measurements, inhibiting use of overlapped SMTC occasions, and allocating the MG occasions to be used for measurement of the other measurement objects.

Example 30 can include Example 29 and wherein, when all of the SMTC occasions are within less than the temporal proximity threshold of any of the MG occasions, a measurement resource sharing scaling factor is set to be equal to one, and the measurement resource sharing scaling factor is used for allocating the measurement resources.

Example 31 can include Example 29 and wherein, when any but not all of the SMTC occasions are within less than the temporal proximity threshold of any of the MG occasions, a measurement resource sharing scaling factor is set to be equal to a fraction having a numerator equal to a first number of SMTC windows within a measurement gap repetition period (MGRP) that do not conflict with any MG within the MGRP and a denominator equal to a total number of SMTC windows within the MGRP, and the measurement resources are allocated according to the measurement resource sharing scaling factor.

Example 32 can include Example 29 and wherein, when all of the SMTC occasions are within less than the temporal proximity threshold of any of the MG occasions, the measurement resources are allocated in a round-robin manner among the gapless measurements and other measurement objects.

Example 33 can include a User Equipment (UE) comprising a memory and a processor coupled to the memory and configured to execute instructions stored in the memory to cause the UE to determine a first measurement gap (MG) occasion closest in time to a first synchronization signal block (SSB) based measurement timing configuration (SMTC) occasion; apply a temporal proximity rule to determine if the first SMTC occasion is fully overlapped, partially overlapped, or not overlapped in time with the first MG occasion; when a first MG occasion full overlap exists for the first SMTC occasion, assign a first non-SMTC measurement to occur at the first MG occasion; and, when a first MG occasion partial overlap exists for the first SMTC occasion, inhibit measurement during the first SMTC occasion.

Example 34 can include Example 33 and wherein the processor is further configured, by executing the instructions, cause the UE to, when the first MG occasion partial overlap exists for the first SMTC occasion, assign a second SMTC occasion, the second SMTC occasion being non-overlapping, for performance of a SMTC measurement.

Example 35 can include Example 33 and Example 34 and wherein the SMTC occasion and the second SMTC occasion are within a single MG repetition period (MGRP).

Example 36 can include Example 33 and Example 34 and wherein the processor is further configured, by executing the instructions, cause the UE, when the first MG occasion partial overlap exists for the first SMTC occasion, to assign the first MG occasion for performance of the first non-SMTC measurement.

Example 37 can include Example 33 and Example 34 and Example 36 and wherein the processor is further configured, by executing the instructions, cause the UE to determine a second MG occasion closest in time to a third SMTC occasion; apply the temporal proximity rule to determine if the third SMTC occasion is fully overlapped, partially overlapped, or not overlapped in time with the second MG occasion; when a second MG occasion full overlap exists for the third SMTC occasion, assign a non-SMTC measurement to occur at the second MG occasion; and, when a second MG occasion partial overlap exists for the third SMTC occasion, inhibit measurement during the third SMTC occasion.

Example 38 can include Example 33 and Example 34 and Example 36 and Example 37 and wherein the first MG occasion and the second MG occasion are within a single MG repetition period (MGRP).

Example 39 can include Example 33 and wherein the processor is further configured, by executing the instructions, cause the UE, when a first MG occasion full overlap exists for the first SMTC occasion, to inhibit a second non-SMTC measurement during a second MG occasion and assign a first SMTC measurement to occur at a second SMTC occasion overlapping with the second MG occasion.

Example 40 can include Example 33 and Example 39 and wherein the first MG occasion and the second MG occasion are within a single MG repetition period (MGRP).

Example 41 can include a User Equipment (UE), comprising a memory and a processor coupled to the memory and configured to execute instructions stored in the memory to cause the UE to for a first SMTC temporal window, determine a first temporal proximity of the first SMTC temporal window to a closest first measurement gap (MG); for a second SMTC temporal window, determine a second temporal proximity of the second SMTC temporal window to a closest second MG; determine if the first temporal proximity is less than a minimum acceptable threshold; determine if the second temporal proximity is less than the minimum acceptable threshold; determine if all of a plurality of SMTC temporal windows within a measurement gap repetition period (MGRP) have respective temporal proximities to respective closest MGs of less than the minimum acceptable threshold, the plurality of SMTC temporal windows comprising the first SMTC temporal window and the second SMTC temporal window, the respective temporal proximities comprising the first temporal proximity and the second temporal proximity, and the respective closest MGs comprising the closest first MG and the closest second MG; when all of a plurality of SMTC temporal windows within the MGRP have respective temporal proximities to respective closest MGs of less than the minimum acceptable threshold, inhibit measurement use of the closest first MG, use the first SMTC temporal window for a first synchronization signal block (SSB) measurement, inhibit SSB measurement use of the second SMTC temporal window, and use the closest second MG for a measurement object (MO) measurement; when the first temporal proximity is at least the minimum acceptable threshold, use the first SMTC temporal window for the first SSB measurement, and use the closest second MG for the MO measurement.

Example 42 can include Example 41 and wherein a different MG is used for a second MO measurement.

Example 43 can include Example 41 and wherein the MO measurement and the second MO measurement are repeated in a round-robin manner at subsequent MGs.

Example 44 can include Example 41 and wherein a conflicting MG of the subsequent MGs is inhibited from use for a subsequent MO measurement, and a conflicting SMTC window temporally proximate to the conflicting MG is used for a subsequent SSB measurement.

Example 45 can include Example 41 and wherein, when all of a plurality of SMTC temporal windows within the MGRP have respective temporal proximities to respective closest MGs of less than the minimum acceptable threshold, a measurement resource sharing scaling factor is set to have a value of one, and the measurement resource sharing scaling factor is used to allocate measurement resources.

Example 46 can include Example 41 and wherein, when the first temporal proximity is at least the minimum acceptable threshold, the measurement resource sharing scaling factor is set to have a value of less than one, and the measurement resource sharing scaling factor is used to allocate measurement resources.

Example 47 can include Example 41 and wherein, when the first temporal proximity is at least the minimum acceptable threshold, the measurement resource sharing scaling factor is set to have a value equal to a fraction having a numerator equal to a first number of SMTC windows within a measurement gap repetition period (MGRP) that do not conflict with any MG within the MGRP and a denominator equal to a total number of SMTC windows within the MGRP, and the measurement resource sharing scaling factor is used to allocate measurement resources.

Example 48 can include Example 41 and wherein the closest first MG and the closest second MG both occur within a temporal span of less than a measurement gap repetition period (MGRP).

Example 49 can include Example 41 and wherein a different MG is used for a second MO measurement.

Example 50 can include Example 41 and wherein the MO measurement and the second MO measurement are repeated in a round-robin manner at subsequent MGs.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given or particular application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A User Equipment (UE), comprising one or more processors configured to cause the UE to:
determine, for each of a plurality of gapless synchronization signal block (SSB) based measurement timing configuration (SMTC) occasions within a measurement gap repetition period (MGRP), a measurement gap (MG) occasion that is closest in time;
determine whether each of the plurality of gapless SMTC occasions is overlapped with a corresponding closest in time MG occasion;
determine a measurement resource sharing scheme based on the determining of whether each of the plurality of gapless SMTC occasions is overlapped with the corresponding closest in time MG occasion; and
conduct one or more measurements based on the measurement resource sharing scheme.

2. The UE of claim 1, wherein the measurement resource sharing scheme comprises:
when each of the plurality of gapless SMTC occasions is overlapped with the corresponding closest in time MG occasion, the plurality of gapless SMTC occasions equally shares measurement resources with other measurement objects using MG occasions.

3. The UE of claim 1, wherein the measurement resource sharing scheme comprises:
when each of the plurality of gapless SMTC occasions is overlapped with the corresponding closest in time MG occasion, a first overlapped gapless SMTC occasion is enabled for use for a gapless measurement, a first overlapped MG occasion is inhibited, the first overlapped MG occasion situated within a temporal proximity threshold of the first overlapped gapless SMTC occasion, a second overlapped gapless SMTC occasion is inhibited, and a second overlapped MG occasion is enabled for use for gap based measurement, the second overlapped MG occasion situated within a temporal proximity threshold of the second overlapped SMTC occasion.

4. The UE of claim 1, wherein the measurement resource sharing scheme comprises:
when fewer than all of a plurality of gapless SMTC occasions are overlapped with the corresponding closest in time MG occasion, a first non-overlapped gapless SMTC occasion is enabled for use for a gapless measurement, a first overlapped gapless SMTC occasion is inhibited, and a first overlapped MG occasion is enabled for use for gap based measurement, the first overlapped MG occasion situated within a temporal proximity threshold of the first overlapped SMTC occasion.

5. The UE of claim 1, wherein the measurement resource sharing scheme comprises:
inhibiting, when a first MG occasion is within a temporal proximity threshold of a second MG occasion, use of the first MG occasion and enabling use of the second MG occasion for gap based measurement.

6. The UE of claim 1, wherein the measurement resource sharing scheme comprises:
when each of the plurality of gapless SMTC occasions is overlapped with the corresponding closest in time MG occasion, and a first MG occasion is overlapped with a second MG occasion, the plurality of gapless SMTC occasions equally shares measurement resources with other measurement objects (MOs) using the first and second MG occasions.

7. (canceled)

8. The UE of claim 1, wherein the measurement resource sharing scheme comprises:
when at least one gapless SMTC occasion of the plurality of gapless SMTC occasions is not overlapped with the corresponding closest in time MG occasion, the plurality of gapless SMTC occasions are measured only during the at least one gapless SMTC occasion and not measured during other gapless SMTC occasions that overlap with any of the MG occasions.

9. The UE of claim 1, wherein the measurement resource sharing scheme comprises:
allocating, when each of the plurality of gapless SMTC occasions is overlapped with the corresponding closest in time MG occasion, measurement resources in a round-robin manner among gapless measurements during a subset of the plurality of gapless SMTC occasions and other measurement objects during MG occasions.

10. The UE of claim 1, wherein the measurement resource sharing scheme comprises:
allocating, when fewer than all of a plurality of gapless SMTC occasions are overlapped with the corresponding closest in time MG occasion, measurement resources to provide gapless measurements during the plurality of gapless SMTC occasions in proportion to other measurement objects using MG occasions according to a measurement resource sharing scaling factor having a value equal to a fraction having a numerator equal to a first number of SMTC windows within the MGRP that do not conflict with any MG within the MGRP and a denominator equal to a total number of SMTC windows within the MGRP.

11. The UE of claim 1, wherein the measurement resource sharing scheme comprises:
when a first MG occasion is beyond a temporal proximity threshold away from a second MG occasion and the second MG occasion is within the temporal proximity threshold of a first SMTC occasion, enabling use of the first MG occasion for measurement according to a measurement object (MO), inhibiting use of the second MG occasion, and enabling use of the first SMTC occasion for a gapless measurement.

12. The UE of claim 11, wherein enabling use of the first MG occasion comprises:
selecting the MO according to a round-robin selection among a plurality of MOs associated with any of one or more MGs.

13. (canceled)

14. (canceled)

15. (canceled)

16. (canceled)

17. (canceled)

18. (canceled)

19. The UE of claim 1, wherein the measurement resource sharing scheme comprises:
selecting, when a first SMTC occasion is within a temporal proximity threshold of a first MG occasion, the first MG occasion is within a temporal proximity threshold of a second MG occasion, and the second MG occasion is within the temporal proximity threshold of a second SMTC occasion, among a plurality of MOs in sequence for respective measurements of the plurality of MOs to be performed, and selecting, when two MGs are defined per MGRP, every once in one more than the a sum of a first number of MOs associated with a first MG and a second number of MOs associated with a second MG, a SSB based measurement to be performed.

20. (canceled)

21. A User Equipment (UE), comprising
a memory; and
a processor coupled to the memory and configured to execute instructions stored in the memory to cause the UE to:
determine, within a first measurement gap repetition period (MGRP), for each of n synchronization signal block (SSB) based measurement timing configuration (SMTC) occasions, a closest in time of m measurement gap (MG) occasions;
apply a temporal proximity rule to determine if the n SMTC occasions are fully overlapped, partially overlapped, or not overlapped in time with the m MG occasions;
when the n SMTC occasions are fully overlapped with the m MG occasions, inhibit measuring during a first MG occasion of the m MG occasions within a temporal proximity threshold of a first SMTC occasion of the n SMTC occasions, assign the first SMTC occasion to be used for a first SMTC measurement, inhibit measuring during a second SMTC occasion of the n SMTC occasions within the temporal proximity threshold of a second MG occasion, and assign the second MG occasion to be used for a first non-SMTC measurement; and
when the n SMTC occasions are partially overlapped with the m MG occasions, inhibit measuring during a first SMTC occasion of the n SMTC occasions within the temporal proximity threshold of a first MG occasion of the m MG occasions, assign the first MG occasion to be used for a first non-SMTC measurement, and assign a second SMTC occasion to be used for a second SMTC measurement, the second SMTC occasion beyond the temporal proximity threshold away from any of the m MG occasions.

22. The UE of claim 21, wherein the processor is further configured, by executing the instructions, cause the UE to:
when the n SMTC occasions are fully overlapped with the m MG occasions, inhibit measuring during a third MG occasion within the temporal proximity threshold of a third SMTC occasion of the n SMTC occasions, assign the third SMTC occasion to be used for a second SMTC measurement, inhibit measuring during a fourth SMTC occasion of the n SMTC occasions, and assign a fourth MG occasion in to be used for a second non-SMTC measurement.

23. (canceled)

24. The UE of claim 21, wherein the processor is further configured, by executing the instructions, cause the UE to:
inhibit, when the n SMTC occasions are fully overlapped with the m MG occasions, when a third MG occasion is within the temporal proximity threshold of the first MG occasion, measuring during the third MG occasion.

25. (canceled)

26. The UE of claim 21, wherein the processor is further configured, by executing the instructions, cause the UE to:
when the n SMTC occasions are partially overlapped with the m MG occasions, inhibit measuring during a third SMTC occasion of the n SMTC occasions within the temporal proximity threshold of a second MG occasion, assign the second MG occasion to be used for a second non-SMTC measurement, and assign a third SMTC occasion to be used for a third SMTC measurement, the third SMTC occasion beyond the temporal proximity threshold away from any of the m MG occasions.

27. (canceled)

28. The UE of claim 21, wherein the processor is further configured, by executing the instructions, cause the UE to:
assign, when the n SMTC occasions are partially overlapped with the m MG occasions, when a third SMTC occasion is beyond the temporal proximity threshold away from a third MG occasion, the third SMTC occasion to be used for a second SMTC measurement.

29. A method comprising:
determining, at a user equipment (UE), for a period of time at least as long as a measurement gap repetition period (MGRP), if all synchronization signal block (SSB) measurement timing configuration (SMTC) occasions are within less than an temporal proximity threshold of any of one or more measurement gap (MG) occasions;
allocating, at the UE, when all of the SMTC occasions are within less than the temporal proximity threshold of any of the MG occasions, measurement resources to provide equal sharing among gapless measurements during a subset of the SMTC occasions and other measurement objects during a subset of the one or more MG occasions;
determining, at the UE, for the period of time, if any but not all of the SMTC occasions are within less than the temporal proximity threshold of any of the one or more MG occasions; and
when any but not all of the SMTC occasions are within less than the temporal proximity threshold of any of the MG occasions, allocating, at the UE, non-overlapped SMTC occasions of the SMTC occasions to be used for gapless measurements, inhibiting use of overlapped SMTC occasions, and allocating the MG occasions to be used for measurement of the other measurement objects.

30. The method of claim 29, wherein, when all of the SMTC occasions are within less than the temporal proximity threshold of any of the MG occasions, a measurement resource sharing scaling factor is set to be equal to one, and the measurement resource sharing scaling factor is used for allocating the measurement resources.

31. The method of claim 29, wherein, when any but not all of the SMTC occasions are within less than the temporal proximity threshold of any of the MG occasions, a measurement resource sharing scaling factor is set to be equal to a fraction having a numerator equal to a first number of SMTC windows within the a MGRP that do not conflict with any MG within the MGRP and a denominator equal to a total number of SMTC windows within the MGRP, and the measurement resources are allocated according to the measurement resource sharing scaling factor.

32. (canceled)
